(19) United States
(12) Patent Application Publication
(10) Pub. No.: US 2023/0169588 A1
(43) Pub. Date: Jun. 1, 2023

(54) FACILITATING FEE-FREE CREDIT-BASED WITHDRAWALS OVER COMPUTER NETWORKS UTILIZING SECURED ACCOUNTS

(71) Applicant: Chime Financial, Inc., San Francisco, CA (US)

(72) Inventors: Taylor Lentz, South Lake Tahoe, CA (US); Vanisha Wason, San Francisco, CA (US)

(21) Appl. No.: 17/538,753

(22) Filed: Nov. 30, 2021

(51) Int. Cl. G06Q 40/02; G06Q 20/10

(52) U.S. Cl. CPC G06Q 40/025; G06Q 20/1085

(57) ABSTRACT

This disclosure describes a fee-free credit withdrawal system that, as part of an inter-network facilitation system, can intelligently facilitate credit-based withdrawals across computer networks on a fee free basis to improve accuracy and efficiency of computing systems. For example, the disclosed systems can link a secured account to a credit account unique the system via an authorized network connection to enable fee-free credit-based withdrawals from automated teller machines. Indeed, the disclosed systems can determine (and secure) a credit limit for a credit account based on a balance of the secured account to ensure accurate, up to date indications of the credit limit. Additionally, as a result of securing the credit account in this manner, the disclosed systems can authorize fee-free withdrawal for credit-based withdrawal requests from automated teller machines that are either in network or out of network.

### BACKGROUND

In recent years, both popularity and usage of online finance management systems have increased. Indeed, the proliferation of web and mobile applications has enabled client devices (e.g., mobile phones, tablets, laptop/desktop computers) to utilize online banking systems to view and manage transactions, account balances, and other information over computer networks using an application on the client device. For instance, conventional finance management systems can display, and facilitate management of, account balances and transaction history for accounts associated with specific financial institutions. In addition, some existing finance management systems are centralized for viewing and managing accounts from different financial institutions together in a centralized location or interface. Despite these recent advances, however, conventional finance management systems continue to exhibit a number of drawbacks or deficiencies.

For example, some conventional finance management systems are inaccurate. In particular, conventional systems utilize inaccurate algorithms for determining risk for credit-based withdrawals. Indeed, existing risk algorithms are inaccurate and/or incomplete in their assessment of extending credit withdrawals, especially for accounts with fewer assets, lower income, and/or larger debt. Due to the incompleteness of their risk algorithms, many conventional systems inaccurately apply excessive fees and/or interest rates to credit-based withdrawals (e.g., as a result of missing considerations that would otherwise reduce risk and corresponding fees).

Further relating to inaccuracy, conventional finance management systems sometimes determine inaccurate credit limits for known credit accounts. Indeed, existing systems frequently determine credit limits based on factors such as income, assets, and debt associated with a credit account. However, existing systems require receiving and transmitting large numbers of digital communications across computer networks to update remaining credit limits based on changes to income, expenditures, reimbursements, deposits, transfers, and other financial transactions between credit processors, merchant systems, bank networks, and other subsystems. Due to the wide variety of algorithms and timing rules used by these different subsystems, existing systems often exhibit significant delays in updating credit limits for credit accounts, often reflecting inaccurate credit limits at various times as transactions and/or factors are updated over time across the multiple subsystems.

Due at least in part to their inaccuracy, some conventional finance management systems are also inefficient. Indeed, as a result of determining inaccurate or not up to date credit limits, existing systems often expend excessive computational resources such as computing time and processing power in generating, transmitting, and processing digital communications such as error messages, credit denials, refunds, and duplicative transactions (where such computational expense could otherwise be avoided with more accurate, timely determinations credit limits). In addition, many existing systems exhibit further inefficiency by wasting available network bandwidth and credit account capacity as a result of inaccurate, prohibitive determinations of credit-based withdrawal fees. For instance, because some conventional systems determine excessive fees and interest rates for credit-based withdrawals due to outmoded algorithms, these systems are often so prohibitive that they either push credit accounts toward other systems or prevent use of credit-based withdrawals. Consequently, many existing systems waste computing resources in maintaining network capacity that, in some cases, goes largely unused.

These, along with additional problems and issues, exist with conventional finance management systems.

### SUMMARY

This disclosure describes one or more embodiments of methods, non-transitory computer-readable media, and systems that can solve the foregoing problems in addition to providing other benefits by intelligently facilitating credit-based withdrawals across computer networks on a fee free basis. For example, the disclosed systems can link a secured account to a credit account unique to the system via an authorized network connection to enable fee-free credit-based withdrawals from automated teller machines. Indeed, the disclosed systems can determine (and secure) a credit limit for a credit account based on a balance of the secured account to ensure accurate, up to date indications of the credit limit. Additionally, as a result of securing the credit account in this manner, the disclosed systems can authorize fee-free withdrawal for credit-based withdrawal requests from automated teller machines that are either in network or out of network.

### BRIEF DESCRIPTION OF THE DRAWINGS

The detailed description refers to the drawings briefly described below.

FIG. 1 illustrates a block diagram of an environment for implementing an inter-network facilitation system and a fee-free credit withdrawal system in accordance with one or more embodiments.

FIG. 2 illustrates an example sequence flow for facilitating credit-based withdrawals on a fee-free basis in accordance with one or more embodiments.

FIG. 3 illustrates an example diagram of determining a credit limit in accordance with one or more embodiments.

FIG. 4 illustrates an example diagram for comparing a credit-based withdrawal request with a credit limit in accordance with one or more embodiments.

FIG. 5 illustrates an example diagram for overriding a denial of a credit-based withdrawal request in accordance with one or more embodiments.

FIG. 6 illustrates an example diagram for suppressing fees for fee-free withdrawal in accordance with one or more embodiments.

FIG. 7 illustrates an example diagram for determining whether or not an automated teller machine is in network in accordance with one or more embodiments.

FIGS. 8A-8C illustrate example graphical user interfaces including approval notifications in accordance with one or more embodiments.

FIGS. 9A-9B illustrate example graphical user interfaces including denial notifications in accordance with one or more embodiments.

FIG. 10 illustrates an example graphical user interface including a denial notification for setting up a personal identification number in accordance with one or more embodiments.

FIG. 11 illustrates an example series of acts for facilitating credit-based withdrawals on a fee-free basis in accordance with one or more embodiments.

FIG. 12 illustrates a block diagram of a computing device for implementing one or more embodiments of the present disclosure.

FIG. 13 illustrates an example environment for an inter-network facilitation system in accordance with one or more embodiments.

### DETAILED DESCRIPTION

This disclosure describes a fee-free credit withdrawal system that can accurately and efficiently authorize credit-based withdrawals across computer networks on a fee free basis. To elaborate, the fee-free credit withdrawal system can receive a credit-based withdrawal request from an automated teller machine (“ATM”) that indicates a credit account associated with the fee-free credit withdrawal system. In response to the credit-based withdrawal request, the fee-free credit withdrawal system can determine a credit limit associated with the credit account based on a balance within a secured account linked to the credit account. For example, the fee-free credit withdrawal system can determine a credit limit to match the balance of the secured account. In some embodiments, the fee-free credit withdrawal system prevents accounts or systems other than the linked credit account from accessing the secured account, thus ensuring that the credit limit is accurate and secured. In addition, the fee-free credit withdrawal system can authorize the credit-based withdrawal request (and can provide a corresponding notification for display on a client device) based on comparing the credit limit with an amount of the credit-based withdrawal request. In one or more embodiments, the fee-free credit withdrawal system further suppresses fees associated with the credit-based withdrawal request, which is possible as a result of linking the credit account with the secured account.

As just mentioned, the fee-free credit withdrawal system can receive credit-based withdrawal requests from automated teller machines. In addition, the fee-free credit withdrawal system can authorize a credit-based withdrawal request for fee-free withdrawal. To this end, the fee-free credit withdrawal system can determine a credit account associated with the credit-based withdrawal request and can further determine a credit limit associated with the credit account. For instance, the fee-free credit withdrawal system can determine a credit limit based on a balance within a secured account linked to the credit account.

Indeed, the fee-free credit withdrawal system can determine the credit limit associated with the credit account by matching the credit limit to a remaining balance within the secured account. In some cases, the fee-free credit withdrawal system links the secured account to the credit account by establishing an authorized network connection between the fee-free credit withdrawal system and a secured account management system (e.g., a banking network system). In some cases, based on identifying a secured account linked to the credit account, the fee-free credit withdrawal system can utilize the secured account as security against credit withdrawals from the credit account. Thus, as the balance within the secured account fluctuates with different transactions (e.g., credit and deposits), the fee-free credit withdrawal system can update the credit limit associated with the credit account.

As mentioned above, the fee-free credit withdrawal system can determine an amount associated with a credit-based withdrawal request. In particular, the fee-free credit withdrawal system can receive an indication of a withdrawal amount from an ATM. In addition, the fee-free credit withdrawal system can compare the withdrawal amount against a credit limit associated with a credit account. For example, the fee-free credit withdrawal system can compare the withdrawal amount with a balance within the secured account that secures (and can define the credit limit of) the credit account. In some cases, the fee-free credit withdrawal system determines that the withdrawal amount is less than or equal to the credit limit of the credit account. In other cases, the fee-free credit withdrawal system determines that the withdrawal amount exceeds the credit limit. Based on determining that the withdrawal amount is less than or equal to the credit limit, the fee-free credit withdrawal system can approve or authorize the credit-based withdrawal (e.g., for fee-free withdrawal). Conversely, based on determining that the withdrawal amount is more than the credit limit, the fee-free credit withdrawal system can deny the credit-based withdrawal.

In some embodiments, the fee-free credit withdrawal system can suppress one or more fees associated with a credit-based withdrawal request. To elaborate, upon (or as part of) approval or authorization of a credit-based withdrawal, the fee-free credit withdrawal system can determine fees associated with the credit-based withdrawal request. For instance, the fee-free credit withdrawal system can determine fees based on determining whether the ATM submitting the credit-based withdrawal request is in network or out of network. In some embodiments, the fee-free credit withdrawal system determines whether an ATM is partnered based on comparing bank identification numbers (“BINs”) associated with the ATM (or the ATM system that maintains the ATM) with BINs associated with the fee-free credit withdrawal system. In cases where the ATM is partnered with the fee-free credit withdrawal system (e.g., in network), the fee-free credit withdrawal system can determine that there are no fees for the credit-based withdrawal (e.g., via a network connection with a credit processor system).

In cases where the ATM is not partnered with the fee-free credit withdrawal system (e.g., out of network), the fee-free credit withdrawal system can determine one or more fee types associated with the credit-based withdrawal. For example, the fee-free credit withdrawal system can determine a teller machine fee applied by the ATM (e.g., or an ATM system or a terminal owner) for utilizing the ATM. As another example, the fee-free credit withdrawal system can determine an out of network fee for utilizing an ATM associated with an ATM system that is not partnered with the fee-free credit withdrawal system. In some embodiments, the fee-free credit withdrawal system suppresses one or more of the fees associated with a credit-based withdrawal. For example, the fee-free credit withdrawal system reimburses fees applied to a credit-based withdrawal (e.g., a teller machine fee and an out of network fee) and/or provides a fee cancellation instruction to the ATM to cancel or override the application of one or more applicable fees.

In one or more implementations, the fee-free credit withdrawal system can override a denial indication associated with a credit-based withdrawal request. More specifically, upon determining that a withdrawal amount exceeds a credit limit for a credit account, the fee-free credit withdrawal system can nevertheless approve the credit-based withdrawal amount based on a balance within a secondary account. For example, in response to receiving a denial indication from an ATM that a credit-based withdrawal request is going to be denied (e.g., based on comparing a credit limit with a withdrawal amount), the fee-free credit withdrawal system can override the denial indication and authorize the credit-based withdrawal request. Indeed, in certain embodiments, the fee-free credit withdrawal system accesses a secondary account to supplement the credit limit associated with the credit account. For example, the fee-free credit withdrawal system determines a balance within the secondary account and combines the secondary account balance with the credit limit to compare with the withdrawal amount. In some cases, the fee-free credit withdrawal system modifies or updates the credit limit to include a balance within a secondary account, while in other cases the secondary account is used as a failsafe but is not included as part of the credit limit. Additional detail regarding the secondary account is provided below with reference to the figures.

In one or more embodiments, the fee-free credit withdrawal system can determine a fee-free limit amount for a credit account. For example, based on usage history of the credit account and/or other factors (e.g., age of credit account and payment history), the fee-free credit withdrawal system can determine a fee-free limit amount that acts as a cap on a fee-free withdrawal amount for the credit account. In some cases, the fee-free credit withdrawal system determines that a fee-free limit amount is less than a total credit limit of a credit account. In these or other cases, the fee-free credit withdrawal system facilitates fee-free credit-based withdrawal for amounts up to the fee-free limit amount and facilitates fee-based withdrawal for amounts exceeding the fee-free limit amount. In some embodiments, the fee-free credit withdrawal system can split a single credit-based withdrawal that exceeds a fee-free limit amount into two portions, one that is fee-free (for the portion up to the fee-free limit amount) and one that is fee-based (for the portion that exceeds the fee-free limit amount).

As suggested above, the disclosed fee-free credit withdrawal system provides several improvements or advantages over conventional finance management systems. For instance, the fee-free credit withdrawal system can improve accuracy compared to conventional systems. While many existing systems erroneously apply excessive fees and/or interest rates to credit-based withdrawals due to their incomplete and/or inaccurate risk models, the fee-free credit withdrawal system can more accurately facilitate fee-free credit-based withdrawals. Indeed, facilitating fee-free credit-based withdrawals is a function not found in existing systems because credit-based withdrawals by their nature are too risky under conventional risk models. The fee-free credit withdrawal system, by contrast, utilizes a more intelligent, more complete risk model. Indeed, in some embodiments, fee-free credit withdrawal system utilizes a secured account linked to a credit account to dictate the credit limit of the credit account, thereby mitigating risk (e.g., by guaranteeing funds for payment of credit-based withdrawals) and enabling fee-free withdrawals on credit. Conventional systems include no such consideration or functionality of linking secured accounts to credit accounts for managing credit limits.

Along these lines, in some embodiments the fee-free credit withdrawal system ensures security of the secured account. For example, the fee-free credit withdrawal system prevents withdrawal from the secured account by all accounts other than the credit account. Indeed, the fee-free credit withdrawal system can link the secured account to the credit account such that only the credit account is allowed to withdraw funds from the secured account. Thus, the fee-free credit withdrawal system can prevent inaccurate credit limit determinations and improper credit usage where, for example, a credit account indicates a credit-based withdrawal for an entire balance of the secured account and a member subsequently withdraws the same amount on debit before the credit amount is deducted from the secured account.

Further relating to the improved accuracy of the fee-free credit withdrawal system, in some embodiments, the fee-free credit withdrawal system determines more accurate credit limits than conventional finance management systems. Compared to conventional systems that require large numbers of digital communications across various computer networks to update financial transactions between subsystems, the fee-free credit withdrawal system can determine a credit limit based solely on a balance of a linked secured account. Indeed, the fee-free credit withdrawal system is faster than prior systems in updating credit limits, reflecting accurate, up to date credit limits based only on a remaining balance within the secured account (irrespective of other factors). For example, while some existing systems are slow to update credit limits based on changes to income, credit history, assets, debts, and various transactions, the fee-free credit withdrawal system quickly and accurately updates credit limits according to the balance of the secured account.

Due at least in part to its improved accuracy, the fee-free credit withdrawal system can further exhibit improved efficiency over conventional systems as well. Indeed, the fee-free credit withdrawal system can improve efficiency over conventional systems that have introduced computational hurdles that did not exist prior to the advent of network-based transaction processing. For example, in some embodiments, the fee-free credit withdrawal system saves computing resources by processing fewer digital communications (and using a simpler algorithm) to update credit limits. Indeed, the fee-free credit withdrawal system need only determine a balance within a secured account, while conventional systems transmit and receive large numbers of digital communications across many networks to determine credit limits using much more complex algorithms.

In addition, the fee-free credit withdrawal system saves additional computing resources, as compared to conventional systems, by preventing wasteful generating, transmitting, and processing of error messages, credit denials, refunds, and duplicative transactions. Indeed, as a result of more accurately determining credit limits (e.g., directly from secured account balances), the fee-free credit withdrawal system reduces the numbers of errors, denials, and duplicative transactions, thereby preserving computing resources that existing systems dedicate to generating and processing these digital communications.

Further relating to improved efficiency, the fee-free credit withdrawal system can more efficiently utilize available network bandwidth compared to conventional systems. Indeed, while some conventional systems waste available network bandwidth as a result of inaccurate, prohibitive determinations of credit-based withdrawal fees, the fee-free credit withdrawal system can more efficiently utilize available bandwidth by facilitating fee-free credit-based withdrawals. For instance, while prior systems push credit accounts toward other systems and/or prevent use of credit-based withdrawals altogether, the fee-free credit withdrawal system utilizes smarter credit accounts linked to secured accounts to facilitate fee-free withdrawals on credit. Thus, the fee-free credit withdrawal system can more efficiently utilize network bandwidth capacity available for managing larger numbers of credit accounts and for processing credit-based withdrawals.

As a further advantage, the fee-free credit withdrawal system improves upon prior risk models to catch or include qualified credit accounts missed by conventional systems. To elaborate, the outmoded credit limit determinations and risk models relied on by existing systems prevents these existing from extending credit to otherwise qualified accounts. Indeed, in many cases, conventional systems require credit qualifications that exclude large numbers of potential credit accounts. The fee-free credit withdrawal system, on the other hand, utilizes an improved paradigm with more accurate, secure credit limit determinations (e.g., based on secured accounts linked to credit accounts) to facilitate credit accounts that would otherwise fall through the cracks under conventional credit models.

As indicated by the foregoing discussion, the present disclosure utilizes a variety of terms to describe features and advantages of the fee-free credit withdrawal system. For example, as used herein, the term “credit account” refers to an account within an online financial management system that operates on credit transactions. For instance, a credit account includes an online account with a digital balance that indicates a credit limit within the credit account. In some cases, a credit account is maintained by the fee-free credit withdrawal system, while in other cases a credit account is maintained by a separate credit processing system. Relatedly, the term “credit limit” refers to a balance of a credit account that indicates a maximum total amount accessible on credit from the credit account (e.g., for a particular time period). For example, a credit limit indicates an amount withdraw-able from a credit account utilizing credit-based withdrawals. In some cases, a credit limit reflects or matches a balance within a secured account linked to a credit account.

Along these lines, the term “secured account” refers to an online account linked to a credit account and that secures a credit limit associated with the credit account. In particular, a secured account includes a balance of a certain amount which corresponds to or defines a credit limit of a linked credit account. In certain embodiments, a secured account is accessible for deposit from one or more other accounts but only accessible for withdrawal (or other deductions) via the linked credit account.

In some cases, a secured account is affiliated with, or managed by, a different online banking system apart from the fee-free credit withdrawal system. In particular, the secured account can be linked to the credit account via an authorized network connection. As used herein, the term “authorized network connection” refers to a network connection between two computing systems that is authorized by a managing user. For example, an authorized network connection includes a network connection that is persistent or automatically repeatable for multiple sessions (or for a certain time period) so that the fee-free credit withdrawal system can access the secured account from a separate computing system without requiring repeated manual (e.g., user-entered) authentication for each access attempt.

As mentioned above, a credit account is maintained by the fee-free credit withdrawal system, which is part of an inter-network facilitation system. As used herein, the term “inter-network facilitation system” refers to a system that includes the fee-free credit withdrawal system and that facilitates financial transactions and digital communications across different computing systems over one or more networks. For example, an inter-network facilitation system manages credit accounts, secured accounts, and other accounts for a single account registered within the inter-network facilitation system. In some cases, the inter-network facilitation system is a centralized network system that facilitates access to online banking accounts, credit accounts, and other accounts within a central network location. Indeed, the inter-network facilitation system can link accounts from different network-based financial institutions to provide information regarding, and management tools for, the different accounts.

As mentioned above, the fee-free credit withdrawal system can receive a credit-based withdrawal request from an ATM. As used herein, the term “credit-based withdrawal request” refers to a digital request for withdrawal of currency based on credit associated with a credit account. For instance, a credit-based withdrawal refers to a cash withdrawal from an ATM or other source that is accomplished via credit rather than debit. In some cases, a credit-based withdrawal includes a “fee-free withdrawal” that refers to a credit-based withdrawal that incurs no fees (or that has fees suppressed by the fee-free credit withdrawal system). For example, a fee-free withdrawal includes a credit-based withdrawal of cash from an in network or out of network ATM that nevertheless results in a net total of zero fees applied to an associated credit account (or corresponding secured account).

In one or more embodiments, the fee-free credit withdrawal system can determine a fee-free limit amount for a credit account. As used herein, the term “fee-free limit amount” refers to an upper limit for withdrawing fee-free on credit. For example, a fee-free limit amount includes an upper bound for credit-based withdrawals to remain fee-free. In some cases, credit-based withdrawals that exceed the fee-free limit amount do not qualify for fee-free withdrawal, and the fee-free credit withdrawal system therefore does not suppress any fees applied to the withdrawal request. In certain embodiments, the fee-free credit withdrawal system can split a single credit-based withdrawal request into two portions according to a fee-free limit amount, where a withdrawal amount up to the fee-free limit amount is fee-free and an amount (of the same withdrawal) exceeding the fee-free limit amount is fee-based.

In certain implementations, the fee-free credit withdrawal system can utilize a secondary account to override denial indications for credit-based withdrawals. As used herein, the term “secondary account” refers to an account within the fee-free credit withdrawal system (or the inter-network facilitation system) that indicates an advancement amount for a particular credit account. For example, a secondary account can reflect or include an amount of currency that the fee-free credit withdrawal system determines to advance to the credit account based on usage history, payment history, and other account-specific factors within the inter-network facilitation system. Indeed, in some cases, a secondary account is not a conventional bank account accessible outside of the inter-network facilitation system but is instead an internal, system-specific account that includes a balance that the system determines is advance-able to the credit account based on the aforementioned factors. Thus, based on determining that a withdrawal amount exceeds a credit limit for a credit account (and that the withdrawal request will otherwise be denied), the fee-free credit withdrawal system can access a secondary account associated with the credit account to determine a supplemental balance to approve the withdrawal request.

In some embodiments, the fee-free credit withdrawal system 102 utilizes a secondary account balance machine learning model to generate a secondary account balance for a credit account. As used herein, the term “machine learning model” refers to a computer algorithm or a collection of computer algorithms that automatically improve for a particular task through experience based on use of data. For example, a machine learning model can utilize one or more learning techniques to improve in accuracy and/or effectiveness. Example machine learning models include various types of decision trees, support vector machines, Bayesian networks, linear regressions, logistic regressions, random forest models, or neural networks (e.g., deep neural networks).

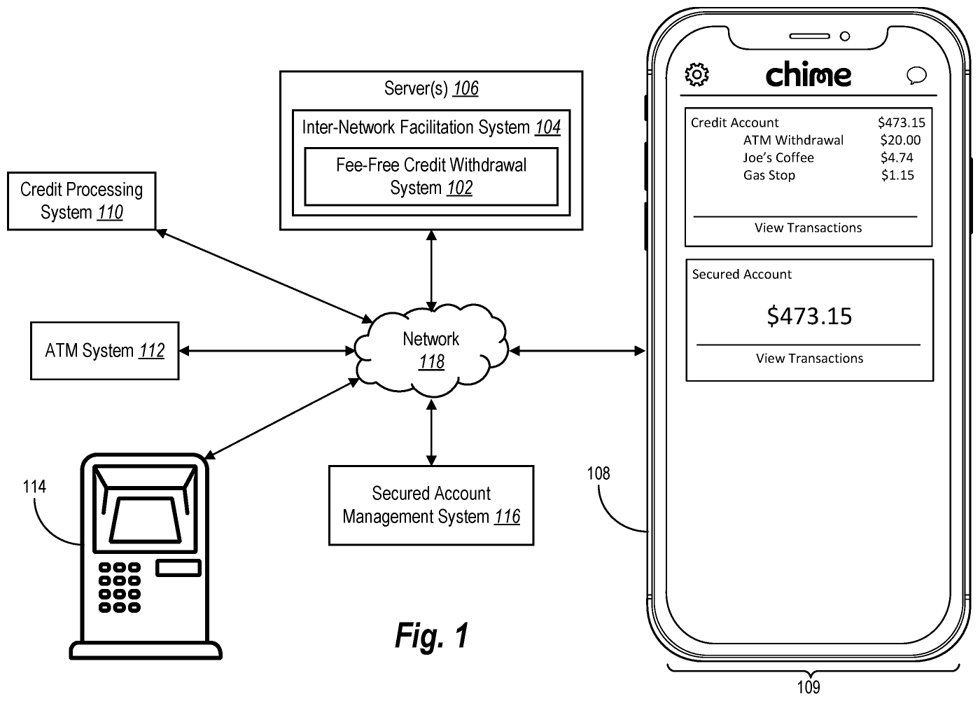

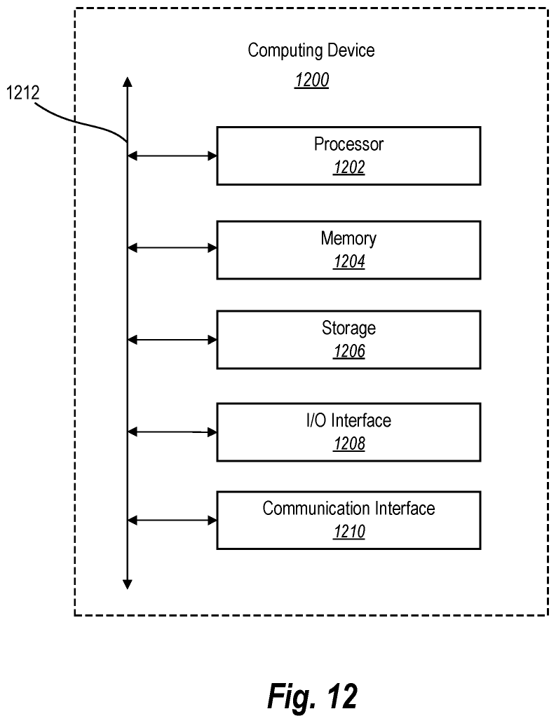

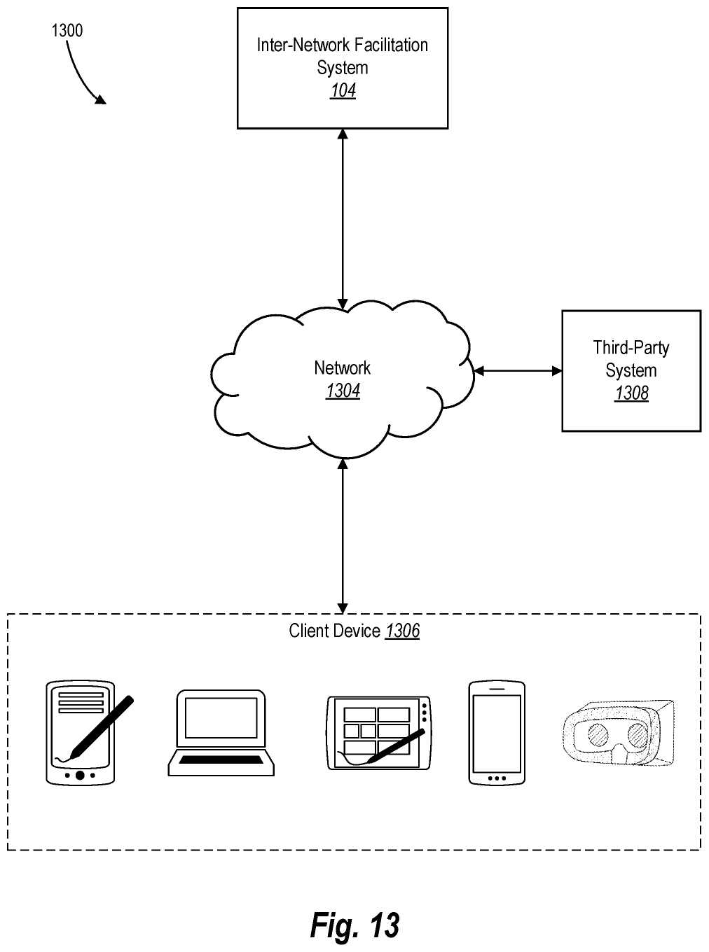

Additional detail regarding the fee-free credit withdrawal system will now be provided with reference to the figures. In particular, FIG. 1 illustrates a block diagram of a system environment for implementing a fee-free credit withdrawal system 102 in accordance with one or more embodiments. As shown in FIG. 1, the environment includes server(s) 106 housing the fee-free credit withdrawal system 102 as part of an inter-network facilitation system 104. The environment of FIG. 1 further includes client device 108, a credit processing system 110, an ATM system 112, an ATM terminal 114, and a secured account management system 116. The server(s) 106 can include one or more computing devices to implement the fee-free credit withdrawal system 102. Additional description regarding the illustrated computing devices (e.g., the server(s) 106, the client device 108, the credit processing system 110, the ATM system 112, the ATM terminal 114, and/or the secured account management system 116) is provided with respect to FIGS. 12-13 below.

As shown, the fee-free credit withdrawal system 102 utilizes the network 118 to communicate with the client device 108, the credit processing system 110, the ATM system 112, the ATM terminal 114, and/or the secured account management system 116. The network 118 may comprise any network described in relation to FIGS. 12-13. For example, the fee-free credit withdrawal system 102 communicates with the client device 108 and/or the ATM terminal 114 to provide and receive information pertaining to credit-based withdrawals. Indeed, the inter-network facilitation system 104 or the fee-free credit withdrawal system 102 can receive a credit-based withdrawal request from the ATM terminal 114 (e.g., indicating a withdrawal amount). In response, fee-free credit withdrawal system 102 or the inter-network facilitation system 104 can authorize or deny the credit-based withdrawal request and can provide an notification to the client device 108 indicating the authorization or denial (and can further update account balances and credit limits based on the withdrawal amount).

To facilitate credit-based withdrawal requests, in some embodiments, the inter-network facilitation system 104 or the fee-free credit withdrawal system 102 communicates with the credit processing system 110, the ATM system 112, and/or the secured account management system 116. More specifically, the inter-network facilitation system 104 or the fee-free credit withdrawal system 102 determines a credit limit for a credit account (e.g., a credit account maintained by the fee-free credit withdrawal system 102 or the credit processing system 110) by communicating with the secured account management system 116. For example, the inter-network facilitation system 104 or the fee-free credit withdrawal system 102 accesses a secured account maintained by the secured account management system 116 (e.g., remotely from the server(s) 106) and determines a balance within the secured account.

In one or more embodiments, the inter-network facilitation system 104 or the fee-free credit withdrawal system 102 further communicates with the credit processing system 110 to enable fee-free credit-based withdrawals. In particular, the inter-network facilitation system 104 or the fee-free credit withdrawal system 102 provides an indication of a secured account associated with a credit account to indicate to the credit processing system 110 that the credit account is authorized for fee-free credit-based withdrawals (and to further indicate the credit limit). In addition, the inter-network facilitation system 104 or the fee-free credit withdrawal system 102 communicates with the credit processing system 110 to carry out or execute authorized credit-based withdrawals. For example, the inter-network facilitation system 104 or the fee-free credit withdrawal system 102 provides a withdrawal amount to the credit processing system to update a credit limit associated with a credit account based on a credit-based withdrawal.

In some cases, the inter-network facilitation system 104 or the fee-free credit withdrawal system 102 further communicates with the ATM system 112 to, for example, determine fees associated with a credit-based withdrawal. To elaborate, the inter-network facilitation system 104 or the fee-free credit withdrawal system 102 compares BINs associated with the ATM system 112 (or the specific ATM terminal 114) that manages (or owns) the ATM terminal 114 with BINs associated with the inter-network facilitation system 104 or the fee-free credit withdrawal system 102. By comparing BINs, the inter-network facilitation system 104 or the fee-free credit withdrawal system 102 determines whether the ATM terminal 114 is partnered (e.g., in network) or not partnered (e.g., out of network) with the inter-network facilitation system 104 or the fee-free credit withdrawal system 102.

In some embodiments, the ATM terminal 114 communicates with the credit processing system 110 and/or the secured account management system 116 to determine authorization for a credit-based withdrawal request. For example, the ATM terminal 114 provides a withdrawal amount indication to the credit processing system 110 or the secured account management system 116, whereupon the receiving system compares the withdrawal amount to a credit limit (e.g., a balance with a secured account). Based on the comparison, the credit processing system 110 or the secured account management system 116 provides an authorization or denial indication to the ATM terminal 114. In turn, the ATM terminal 114 provides the authentication or denial indication to the inter-network facilitation system 104 or the fee-free credit withdrawal system 102.

As indicated by FIG. 1, the client device 108 includes the client application 109. In many embodiments, the inter-network facilitation system 104 or the fee-free credit withdrawal system 102 communicates with the client device 108 through the client application 109 to, for example, receive and provide information including a credit limit associated with a credit account, credit account transactions, a secured account balance, secured account transactions, and credit-based withdrawal notifications (e.g., authorization notifications or denial notifications). As shown, the fee-free credit withdrawal system 102 provides credit account information and secured account information for display within a graphical user interface associated with the client application 109.

As indicated above, the inter-network facilitation system 104 or the fee-free credit withdrawal system 102 can provide (and/or cause the client device 108 to display or render) visual elements within a graphical user interface associated with the client application 109. For example, the inter-network facilitation system 104 or the fee-free credit withdrawal system 102 can provide a graphical user interface that includes a credit account element and a secured account element. Within the credit account element, the fee-free credit withdrawal system 102 can digital image classification system can present and update a credit limit and credit transactions including credit-based withdrawals. Within the secured account element, the fee-free credit withdrawal system 102 can present and update a secured account balance (e.g., that matches a credit limit) and secured account transactions including credit account payments, transfers (e.g., transfers into the secured account but not out from the secured account), and deposits.

Although FIG. 1 illustrates the environment having a particular number and arrangement of components associated with the fee-free credit withdrawal system 102, in some embodiments, the environment may include more or fewer components with varying configurations. For example, in some embodiments, the inter-network facilitation system 104 or the fee-free credit withdrawal system 102 can communicate directly with the client device 108, the credit processing system 110, the ATM system 112, the ATM terminal 114, and/or the secured account management system 116, bypassing the network 118. In these or other embodiments, the inter-network facilitation system 104 or the fee-free credit withdrawal system 102 can be housed (entirely on in part) on the client device 108. Additionally, the inter-network facilitation system 104 or the fee-free credit withdrawal system 102 can include or communicate with a database for storing information, such as secured account balances, credit account balances, BINs, and/or other information described herein.

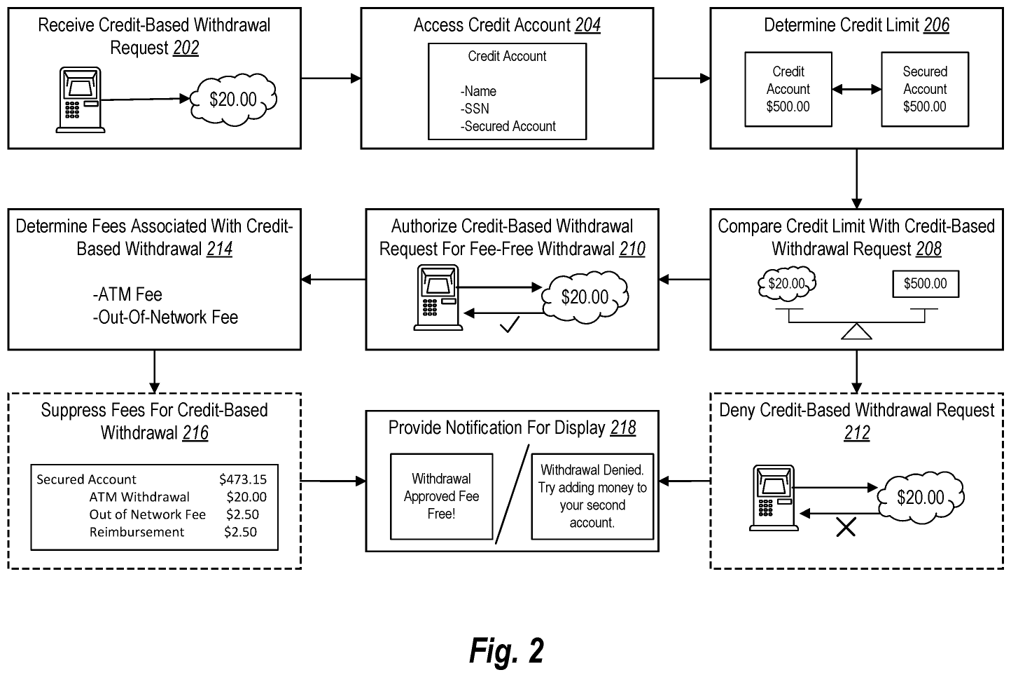

As mentioned, in certain embodiments, the fee-free credit withdrawal system 102 can facilitate fee-free credit-based withdrawals. In particular, the fee-free credit withdrawal system 102 can utilize a secured account linked to a credit account as a basis for facilitating fee-free credit-based withdrawals. FIG. 2 illustrates an overview of a sequence for facilitating fee-free credit-based withdrawals in accordance with one or more embodiments. Thereafter, the description of subsequent figures provides additional detail regarding specific acts or components of facilitating fee-free credit-based withdrawals.

As illustrated in FIG. 2, the fee-free credit withdrawal system 102 performs an act 202 to receive a credit-based withdrawal request. In particular, the fee-free credit withdrawal system 102 receives a credit-based withdrawal request from an ATM (e.g., the ATM terminal 114). For example, the fee-free credit withdrawal system 102 receives a credit-based withdrawal request that indicates a withdrawal amount and that further indicates that the withdrawal amount is to be applied to a credit account associated with the fee-free credit withdrawal system 102. As shown, the fee-free credit withdrawal system 102 receives a credit-based withdrawal request of, for example, $20.00.

As further illustrated in FIG. 2 the fee-free credit withdrawal system 102 performs an act 204 to access a credit account. In particular, the fee-free credit withdrawal system 102 accesses a credit account associated with the credit-based withdrawal request. For instance, the fee-free credit withdrawal system 102 determines or identifies a credit account indicated by the credit-based withdrawal request. In some cases, the fee-free credit withdrawal system 102 identifies the credit account based on comparing information received along with (or as part of) the credit-based withdrawal request with information stored for credit accounts. For example, the fee-free credit withdrawal system 102 compares a name associated with a credit account card used to initiate the credit-based withdrawal request and names of stored credit accounts. In addition, the fee-free credit withdrawal system 102 further compares social security numbers, card numbers, personal identification numbers, and other information from the credit-based withdrawal request and the stored credit accounts to identify a credit account corresponding to the credit-based withdrawal request.

Additionally, the fee-free credit withdrawal system 102 performs an act 206 to determine a credit limit associated with the identified credit account. In particular, the fee-free credit withdrawal system 102 determines a credit limit based on a balance within a secured account. In some embodiments, the fee-free credit withdrawal system 102 accesses a secured account maintained by an external system (e.g., the secured account management system 116) and linked to the credit account within the inter-network facilitation system 104. In addition, the fee-free credit withdrawal system 102 determines a balance within the secured account and utilizes the secured account balance as the credit limit for the credit account.

In certain embodiments, the fee-free credit withdrawal system 102 determines the secured account balance via an authorized network connection between the inter-network facilitation system 104 and the secured account management system 116. Indeed, the fee-free credit withdrawal system 102 can establish an authorized network connection by receiving user-entered authentication and approval for a long-term authorized network connection, where the fee-free credit withdrawal system 102 communicates regularly with the secured account management system 116 (and/or the credit processing system 110) for a certain period of time or for a certain number of sessions or logins before requiring re-authentication. In some cases, the fee-free credit withdrawal system 102 establishes a persistent authorized network connection that remains connected even after a session within the client application 109 is terminated (e.g., to continually update and cross-check a secured account balance with a credit limit). In other cases, the fee-free credit withdrawal system 102 reconnects via the authorized network connection for each new session (or periodically) in the client application 109 to determine a credit limit for the credit account based on the secured account balance. As shown, the fee-free credit withdrawal system 102 determines a credit limit of $500.00 by determining a secured account balance of $500.00.

As further illustrated in FIG. 2, the fee-free credit withdrawal system 102 performs an act 208 to compare the credit limit with a credit-based withdrawal request. More specifically, the fee-free credit withdrawal system 102 compares a credit limit with an amount associated with the credit-based withdrawal request received via the act 202. As shown, the fee-free credit withdrawal system 102 compares the credit limit of $500.00 with the withdrawal amount of $20.00 to determine whether to authorize or deny the credit-based withdrawal request.

Based on comparing the illustrated amounts for the credit-based withdrawal request and the credit limit, the fee-free credit withdrawal system 102 performs an act 210 to authorize the credit-based withdrawal request for fee-free withdrawal. More particularly, the fee-free credit withdrawal system 102 determines that the credit limit of the credit account is sufficient for the credit-based withdrawal request. Thus, the fee-free credit withdrawal system 102 authorizes the credit-based withdrawal request. Additionally, the fee-free credit withdrawal system 102 authorizes the credit-based withdrawal request for fee-free withdrawal.

In some cases, however, the fee-free credit withdrawal system 102 may determine a credit limit of $15.00 or some other amount less than the withdrawal amount. In these cases, the fee-free credit withdrawal system 102 performs an act 212 to deny the credit-based withdrawal request. In particular, the fee-free credit withdrawal system 102 denies the credit-based withdrawal request to prevent the withdrawal from going through for processing by the credit processing system 110 and/or the secured account management system 116. Thus, the fee-free credit withdrawal system 102 maintains (or causes the credit processing system 110 and the secured account management system 116 to maintain) a credit limit and a secured account balance at the levels they were at before the credit-based withdrawal request.

As illustrated, upon authorizing a credit-based withdrawal request for fee-free withdrawal (e.g., via the act 210), the fee-free credit withdrawal system 102 performs an act 214 to determine fees associated with the credit-based withdrawal request. In particular, the fee-free credit withdrawal system 102 determines whether the ATM terminal 114 (or the ATM system 112 that manages the ATM terminal 114) is partnered with the inter-network facilitation system 104. For instance, the fee-free credit withdrawal system 102 determines BINs associated with the ATM terminal 114 (or the ATM system 112) that indicate which banks or other financial institutions are within a shared partnership network. The fee-free credit withdrawal system 102 further compares the BINs of the ATM terminal 114 (or the ATM system 112) with one or more BINs associated with the fee-free credit withdrawal system 102 (or the inter-network facilitation system 104).

Thus, based on determining that a BIN repository associated with the ATM terminal 114 (or the ATM system 112) includes a BIN matching a BIN unique to the fee-free credit withdrawal system 102 or a BIN unique to the inter-network facilitation system 104, then the fee-free credit withdrawal system 102 determines that the ATM terminal 114 is partnered, or in network. Conversely, based on determining that the BIN repository associated with the ATM terminal 114 (or the ATM system 112) does not include a BIN matching a BIN of the fee-free credit withdrawal system 102 or the inter-network facilitation system 104, then the fee-free credit withdrawal system 102 determines that the ATM terminal 114 is not partnered, or out of network.

Based on determining that the ATM terminal 114 belongs to a partner network, the fee-free credit withdrawal system 102 further determines that there are no fees associated with the credit-based withdrawal request. In some cases, however, the fee-free credit withdrawal system 102 can determine that the credit-based withdrawal request does carry one or more fees even when the ATM terminal 114 is in network. For example, the fee-free credit withdrawal system 102 determines a teller machine fee and/or a transaction fee associated with the credit-based withdrawal request.

Based on determining that the ATM terminal 114 does not belong to a partner network the fee-free credit withdrawal system 102 determines one or more fees associated with the credit-based withdrawal request. For instance, the fee-free credit withdrawal system 102 determines a teller machine fee applied by a terminal owner (or the ATM system 112) of the ATM terminal 114. In addition, the fee-free credit withdrawal system 102 determines an out of network fee that applies to withdrawals from ATMs that are not partnered with the inter-network facilitation system 104.

In response to determining fees associated with the credit-based withdrawal request (e.g., via the act 214), the fee-free credit withdrawal system 102 further performs an act 216 to suppress fees for the credit-based withdrawal request. To elaborate, the fee-free credit withdrawal system 102 suppresses or removes fees applied to a credit account or a secured account. In some cases, the fee-free credit withdrawal system 102 suppresses all fees in a uniform manner, while in other cases the fee-free credit withdrawal system 102 suppresses different fee types differently.

For example, the fee-free credit withdrawal system 102 can suppress a teller machine fee and/or an out of network fee by determining a fee amount and reimbursing the fee amount. Indeed, the fee-free credit withdrawal system 102 can determine a fee amount applied to a credit account or to a secured account and can reimburse the same amount to suppress the fee. In some embodiments, the fee-free credit withdrawal system 102 suppresses a fee such as a teller machine fee and/or an out of network fee utilizing a process other than reimbursement. For instance, the fee-free credit withdrawal system 102 can transmit or provide a fee cancelation instruction to the ATM terminal 114 (or to the ATM system 112) to cancel a teller machine fee that would otherwise be applied to a credit account or a secured account. Additionally, the fee-free credit withdrawal system 102 can cancel an out of network fee internally and/or by providing a cancelation instruction to the credit processing system 110.

As further illustrated in FIG. 2, the fee-free credit withdrawal system 102 performs an act 218 to provide a notification for display. In particular, the fee-free credit withdrawal system 102 can provide an authorization notification or an approval notification based on authorizing the credit-based withdrawal request (e.g., via the act 210). For example, the fee-free credit withdrawal system 102 generates and provides an approval notification that indicates that the credit-based withdrawal request was approved fee-free. As shown, the fee-free credit withdrawal system 102 provides a notification that reads “Withdrawal approved fee free!”

If, on the other hand, the fee-free credit withdrawal system 102 denies the credit-based withdrawal request (e.g., via the act 212), then the fee-free credit withdrawal system 102 provides a denial notification. For example, the fee-free credit withdrawal system 102 generates and provides for display a denial notification that indicates that the credit-based withdrawal request was denied. In some cases, the denial notification further includes a reason for denial and/or recommended actions to remedy the denial for resubmitting a credit-based withdrawal request. As shown, the fee-free credit withdrawal system 102 provides a denial notification that says “Withdrawal denied. Try adding money to your account.”

Although FIG. 2 illustrates a particular order for the acts described, in some embodiments, the fee-free credit withdrawal system 102 performs one or more of the aforementioned acts in a different order. For example, the fee-free credit withdrawal system 102 can perform the act 210 to determine fees associated with the credit-based withdrawal request immediately after receiving the credit-based withdrawal request via the act 202 (e.g., before the act 204). Indeed, the fee-free credit withdrawal system 102 can perform the acts of FIG. 2 in any number of arrangements or orders, including perform some acts in parallel and other sequentially. For instance, the fee-free credit withdrawal system 102 can perform the act 214 simultaneously with the act 204 to determine fees associated with a credit-based withdrawal request while also accessing a credit account to determine its credit limit. Further, the fee-free credit withdrawal system 102 can perform the act 216 parallelly with the act 218 to suppress fees for a credit-based withdrawal request while also providing a notification of the credit-based withdrawal request for display on the client device 108.

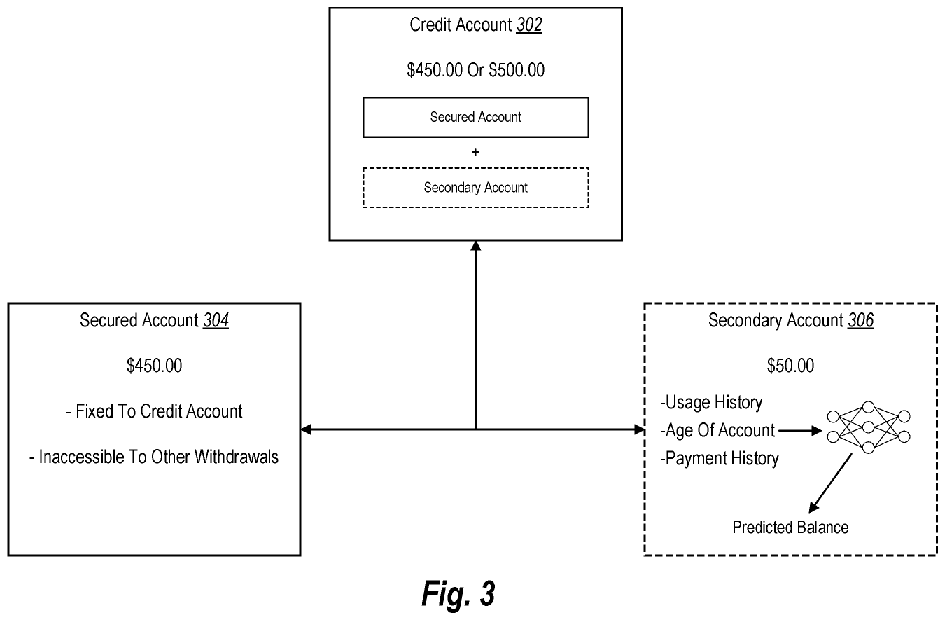

As mentioned above, in certain described embodiments, the fee-free credit withdrawal system 102 can determine a credit limit for a credit account. In particular, the fee-free credit withdrawal system 102 can determine a credit limit associated with a credit account within the inter-network facilitation system 104. As mentioned, in some embodiments a credit account is registered within the inter-network facilitation system 104, while in other embodiments the credit account is registered within the credit processing system 110 and linked to the inter-network facilitation system 104 for interfacing with other accounts and systems. FIG. 3 illustrates an example diagram for determining a credit limit for a credit account in accordance with one or more embodiments.

As illustrated in FIG. 3, the fee-free credit withdrawal system 102 accesses a credit account 302 linked to a secured account 304. In particular, the fee-free credit withdrawal system 102 links the credit account 302 with the secured account 304 via an authorized network connection. For example, the fee-free credit withdrawal system 102 determines that a member or user has provided credentials to authorize linking the credit account 302 and the secured account 304 within the inter-network facilitation system 104 on a permanent or semi-permanent basis. Thus, the fee-free credit withdrawal system 102 can automatically (e.g., without user input or express authorization for each instance) access information and perform transactions associated with and/or between the credit account 302 and the secured account 304.

As shown, the fee-free credit withdrawal system 102 determines a credit limit for the credit account 302 based on a balance within the secured account 304. More specifically, the fee-free credit withdrawal system 102 determines the credit limit to match and coincide with the balance of the secured account 304. Thus, if the fee-free credit withdrawal system 102 detects or determines changes to the balance of the secured account 304, the fee-free credit withdrawal system 102 makes the corresponding adjustments to the credit account. In some cases, the fee-free credit withdrawal system 102 further prevents outgoing transactions of funds from the secured account 304 via any accounts or systems apart from the credit account 302 to ensure security of the funds in relation to the credit limit, thereby mitigating risk and guaranteeing payment for any accumulated credit charges.

In one or more embodiments, the fee-free credit withdrawal system 102 determines the credit limit based on the secured account 304 as well as a secondary account 306. To elaborate, the fee-free credit withdrawal system 102 accesses a secondary account 306 within (e.g., maintained by) the inter-network facilitation system 104 and linked to the credit account 302. For example, the fee-free credit withdrawal system 102 determines a secondary account 306 that includes an advancement amount that the inter-network facilitation system 104 allots to the credit account 302 as an accessible balance of funds in case of emergencies or other unanticipated transaction such as overdrafts. Indeed, in some embodiments, the secondary account 306 is not a traditional banking account or other financial account but is instead inaccessible outside of the inter-network facilitation system 104.

In some cases, the fee-free credit withdrawal system 102 determines funds from the inter-network facilitation system 104 to include within the secondary account 306 as an advancement amount that is later repaid to the inter-network facilitation system 104. In certain implementations, the fee-free credit withdrawal system 102 determines a balance within the secondary account 306 based on factors associated with the credit account 302 such as a usage history, an age of the credit account 302, a payment history, and a behavior history within the inter-network facilitation system 104. In some cases, the fee-free credit withdrawal system 102 caps the secondary account 306 at a maximum value (e.g., $50.00) and determines a percentage or an amount to include within the secondary account 306 (e.g., up to the maximum value) based on one or more of the aforementioned factors.

Indeed, the fee-free credit withdrawal system 102 determines a usage history associated with the credit account 302 that indicates credit expenditures over time, including amounts and purchased goods or services. For example, the fee-free credit withdrawal system 102 determines when and where goods and services were purchased using the credit account 302 and for what amounts. Based on the usage history of the credit account 302, the fee-free credit withdrawal system 102 identifies small purchases (e.g., purchases under a threshold amount), large purchases (e.g., purchases over a threshold amount), and frequencies, timing, or other patterns associated with making certain purchases (e.g., small purchases, large purchases, or purchases of specific amounts). In some embodiments, the fee-free credit withdrawal system 102 determines a higher balance for the secondary account 306 when the credit account 302 has a history of making larger purchases (e.g., more frequently or at certain times).

In addition, the fee-free credit withdrawal system 102 determines an age of the credit account 302. For instance, the fee-free credit withdrawal system 102 determines how long the credit account 302 has existed within the inter-network facilitation system 104. In some embodiments, the fee-free credit withdrawal system 102 determines a higher balance for the secondary account 306 for an older credit account. For example, the fee-free credit withdrawal system 102 compares the age of the credit account 302 with a threshold age (or multiple stages of threshold ages) to determine a balance of the secondary account 306. In certain cases, the fee-free credit withdrawal system 102 determines a directly proportional relationship between account age and secondary account balance.

As further illustrated in FIG. 3, the fee-free credit withdrawal system 102 determines a payment history associated with the credit account 302. More specifically, the fee-free credit withdrawal system 102 determines on-time payments, late payments, payment amounts, payment frequencies, payment timings, and/or automatic payment settings made for the credit account 302. In some cases, the fee-free credit withdrawal system 102 determines a payment history associated with the secondary account 306 based on on-time payments, late payments, payment amounts, payment frequencies, payment timings, and/or automatic payment settings for the secondary account 306 (e.g., to pay back the secondary account 306 to replenish any advancement amount provided from the fee-free credit withdrawal system 102 or the inter-network facilitation system 104 to supplement credit limits). In some embodiments, the fee-free credit withdrawal system 102 determines a higher balance in the secondary account 306 based on timely payments, having fewer than a threshold number of late payments (e.g., over a particular time period), and/or automatic payment settings and a lower balance based on more late payments, less timely payments, and/or not having automatic payments set up.

In addition, the fee-free credit withdrawal system 102 determines a behavior history associated with the credit account 302 as part of determining a balance within the secondary account 306. To elaborate, the fee-free credit withdrawal system 102 determines a frequency of utilizing the client application 109, a total number of sessions within the client application 109, an average duration of application sessions within the client application 109, a number of accounts created within the inter-network facilitation system 104 (e.g., utilizing the client application 109), a frequency of performing transactions (e.g., purchases, withdrawals, deposits, or transfers) utilizing one or more accounts of the inter-network facilitation system 104, and/or a profile completeness within the inter-network facilitation system 104. In some embodiments, the fee-free credit withdrawal system 102 determines a higher balance for the secondary account 306 based on more actions or activity performed via the client application 109 in various sessions.

In some embodiments, the fee-free credit withdrawal system 102 combines two or more of the aforementioned secondary account factors to determine a secondary account balance for the credit account 302. For instance, the fee-free credit withdrawal system 102 utilizes a secondary account balance machine learning model to generate a secondary account balance from the various secondary account factors. In some cases, the fee-free credit withdrawal system 102 inputs the secondary account factors into the secondary account balance machine learning model to generate or predict a balance for the secondary account 306. For example, the secondary account machine learning model is trained to generate a prediction of a balance amount (e.g., within bounds or constraints) based on factors such as usage history, account age, payment history, and/or behavior history. Thus, for different credit accounts (or different member accounts within the inter-network facilitation system 104), the fee-free credit withdrawal system 102 can utilize the secondary account machine learning model to generate different predicted balance amounts for respective secondary accounts.

In one or more embodiments, the fee-free credit withdrawal system 102 determines a credit limit for the credit account 302 based on a combination of a secured account balance and a secondary account balance. For instance, the fee-free credit withdrawal system 102 combines or sums the secured account balance and the secondary account balance to determine the total credit limit for the credit account 302. As shown in FIG. 3, the fee-free credit withdrawal system 102 determines a secondary account balance of $50.00. In addition, the fee-free credit withdrawal system 102 determines a secured account balance of $450.00. Thus, in certain cases, the fee-free credit withdrawal system 102 determines a credit limit of $500.00 for the credit account 302.

In some embodiments, however, the fee-free credit withdrawal system 102 determines the credit limit without considering the secondary account 306. Rather, the fee-free credit withdrawal system 102 utilizes the secondary account 306 as a failsafe where, if a cash-based withdrawal request is going to be denied for exceeding the credit limit, the fee-free credit withdrawal system 102 can override the denial and authorize the cash-based withdrawal request if the withdrawal amount is less than the total of the secured account balance and the secondary account balance. Additional detail regarding overriding withdrawal denials based on the secondary account 306 is provided below with reference to subsequent figures.

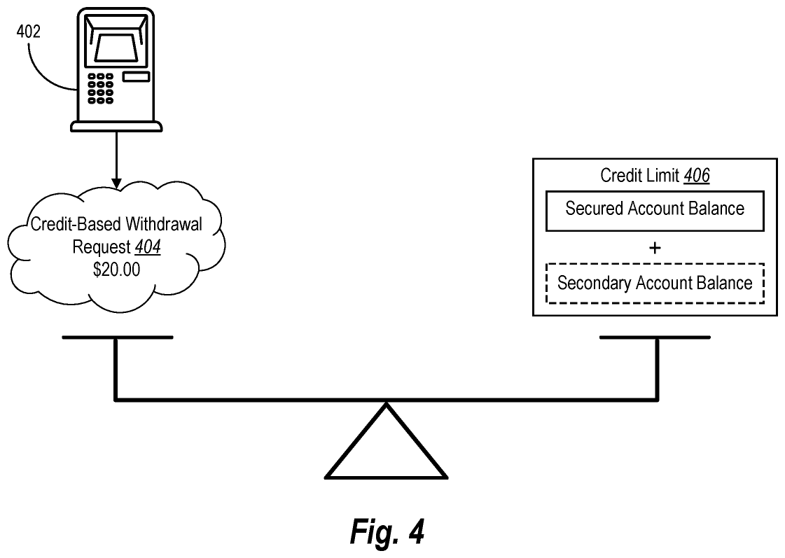

As mentioned above, in certain described embodiments, the fee-free credit withdrawal system 102 can compare a credit limit associated with a credit account with a withdrawal amount associated with a credit-based withdrawal request. In particular, the fee-free credit withdrawal system 102 can compare the withdrawal amount and the credit limit to determine whether to authorize or deny the credit-based withdrawal request. FIG. 4 illustrates an example comparison between a credit-based withdrawal request and a credit limit in accordance with one or more embodiments.

As illustrated in FIG. 4, the fee-free credit withdrawal system 102 receives a credit-based withdrawal request 404 from an ATM terminal 402 (e.g., the ATM terminal 114). In particular, the fee-free credit withdrawal system 102 receives a credit-based withdrawal request indicating a withdrawal amount (e.g., $20.00). In addition, the fee-free credit withdrawal system 102 compares the withdrawal amount associated with the credit-based withdrawal request 404 with a credit limit 406 (e.g., a credit limit associated with the credit account 302). In some cases, the fee-free credit withdrawal system 102 determines that the withdrawal amount is less than the credit limit 406 (e.g., based on a secured account balance or a combined total of a secured account balance and a secondary account balance), and the fee-free credit withdrawal system 102 therefore approves or authorizes the credit-based withdrawal request 404. In other cases, the fee-free credit withdrawal system 102 determines that the credit-based withdrawal request 404 is greater than, or exceeds, the credit limit 406, and the fee-free credit withdrawal system 102 therefore rejects or denies the credit-based withdrawal request 404.

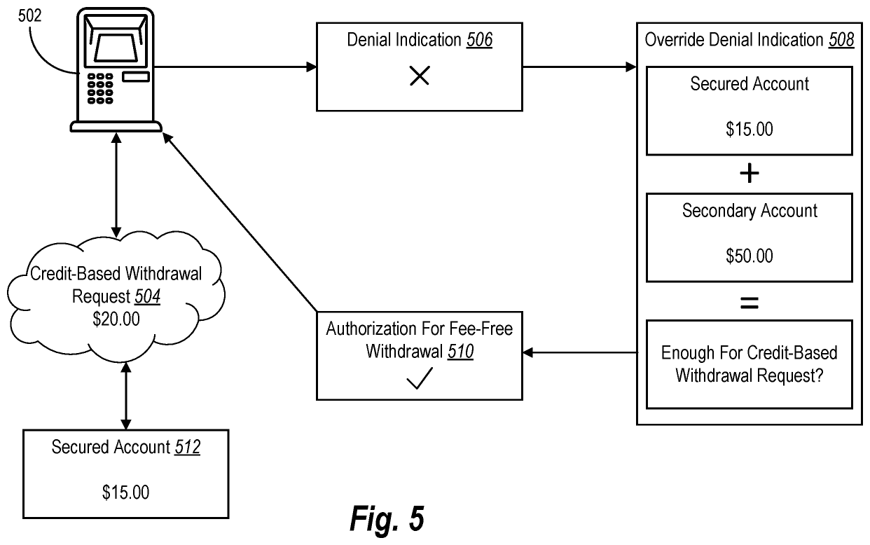

As mentioned above, in certain described embodiments, the fee-free credit withdrawal system 102 can override a denial indication for a credit-based withdrawal request. In particular, the fee-free credit withdrawal system 102 can receive a denial indication (or can otherwise determine) that a credit-based withdrawal request is to be denied based on an insufficient credit limit. FIG. 5 illustrates an example diagram for overriding a denial indication for a credit-based withdrawal request in accordance with one or more embodiments.

As illustrated in FIG. 5, the fee-free credit withdrawal system 102 receives a denial indication 506 from the ATM terminal 502. In particular, the fee-free credit withdrawal system 102 receives a digital communication from the ATM terminal 502 (or the ATM system 112) that indicates that the ATM terminal 502 has determined to deny a credit-based withdrawal request 504. For example, the ATM terminal 502 accesses a secured account 512 (e.g., the secured account 304) by connecting with the secured account management system 116 to determine whether the secured account 512 has sufficient funds for the credit-based withdrawal request 504. Upon determining that the secured account 512 has insufficient funds, the ATM terminal 502 provides the denial indication 506 to the fee-free credit withdrawal system 102.

In some embodiments, the fee-free credit withdrawal system 102 determines whether to approve or deny the credit-based withdrawal request 504 (rather than receiving an indication from the ATM terminal 502). More specifically, the fee-free credit withdrawal system 102 receives a credit-based withdrawal request 504 from an ATM terminal 502 (e.g., the ATM terminal 114). In addition, the fee-free credit withdrawal system 102 determines an amount associated with the credit-based withdrawal request 504 (e.g., $20.00). As described, the fee-free credit withdrawal system 102 further compares the withdrawal amount with a credit limit to determine whether to authorize or deny the credit-based withdrawal request 504. For example, the fee-free credit withdrawal system 102 determines a credit limit of $15.00 based on a balance in a secured account (e.g., the secured account 304) of $15.00. Thus, based on comparing the credit limit with the withdrawal amount, the fee-free credit withdrawal system 102 determines to deny the credit-based withdrawal request 504.

In one or more implementations, the fee-free credit withdrawal system 102 performs the act 508 to override the denial indication 506. In particular, the fee-free credit withdrawal system 102 overrides the denial indication 506 before any actual denial of the credit-based withdrawal request 504 takes place and before a denial notification is sent to the client device 108. As shown, based on receiving the denial indication 506 (or based on determining that the withdrawal amount exceeds a credit limit corresponding to the secured account 512), the fee-free credit withdrawal system 102 performs determines whether the credit account (e.g., the credit account 302) is associated with a secondary account (e.g., the secondary account 306).

In response to determining that the credit account is associated with a secondary account, the fee-free credit withdrawal system 102 determines an amount within the secondary account. In addition, the fee-free credit withdrawal system 102 compares the amount within the secondary account with the withdrawal amount of the credit-based withdrawal request 504. If the fee-free credit withdrawal system 102 determines that the secondary account includes sufficient funds for the credit-based withdrawal request 504, then the fee-free credit withdrawal system 102 overrides the denial indication 506, authorizes the credit-based withdrawal request 504, and provides an authorization for fee-free withdrawal 510 to the ATM terminal 502.

In some embodiments, the fee-free credit withdrawal system 102 overrides the denial indication 506 utilizing a secondary account (e.g., the secondary account 306) in combination with a secured account (e.g., the secured account 304). More specifically, in response to receiving the denial indication 506, the fee-free credit withdrawal system 102 accesses the secured account and the secondary account associated with the credit account. In addition, the fee-free credit withdrawal system 102 combines a balance within the secured account with a balance within the secondary account. Further, the fee-free credit withdrawal system 102 compares the combined total with the withdrawal amount of the credit-based withdrawal request 504. Upon determining that the combined total is sufficient for the credit-based withdrawal request 504, the fee-free credit withdrawal system 102 generates and provides the authorization for fee-free withdrawal 510 to the ATM terminal 502. As shown, the fee-free credit withdrawal system 102 combines the $15.00 from the secured account (not enough for the $20.00 credit-based withdrawal request 504) with the $50.00 from the secondary account to determine that the combined total is enough for the credit-based withdrawal request 504.

In one or more implementations, the authorization for fee-free withdrawal 510 includes an authorization for the credit-based withdrawal request 504 along with one or more fee cancelation instructions. Indeed, the fee-free credit withdrawal system 102 can generate the authorization for fee-free withdrawal 510 to cancel any fees associated with the credit-based withdrawal request 504. For instance, the fee-free credit withdrawal system 102 can provide a cancelation instruction to cancel a teller machine fee associated with the ATM terminal 502.

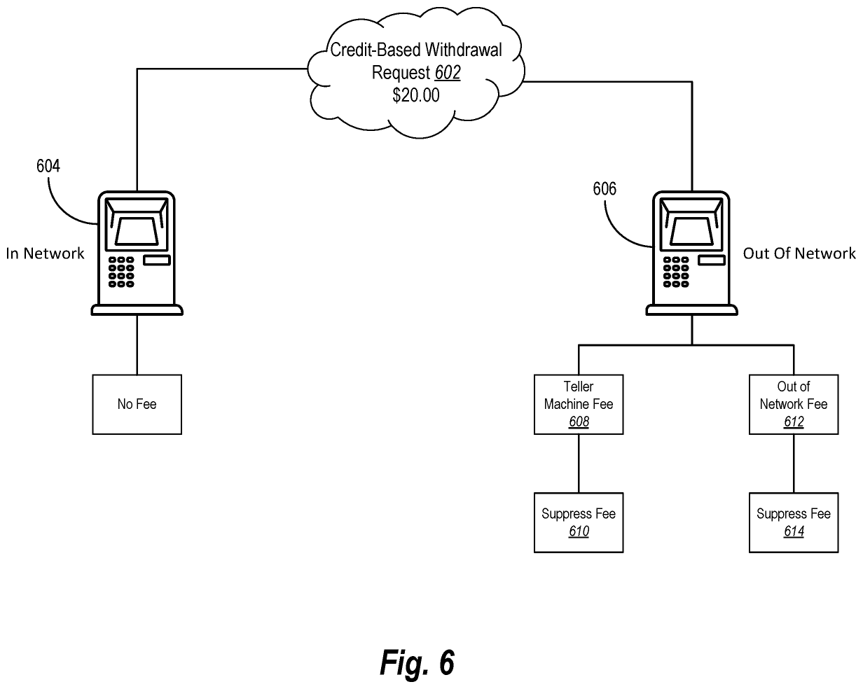

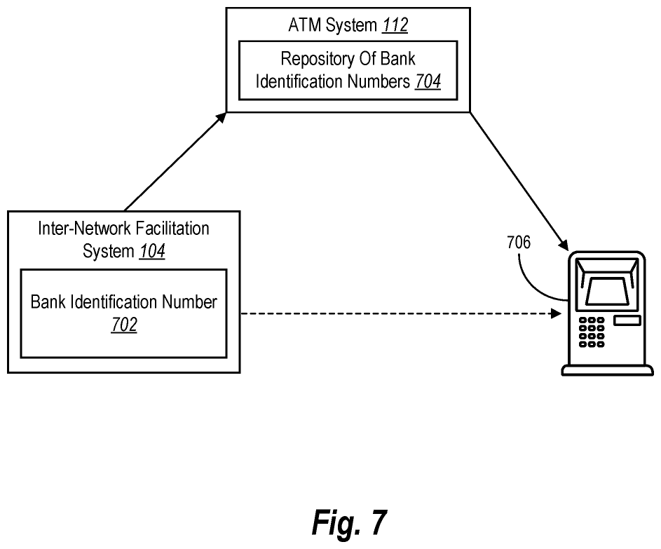

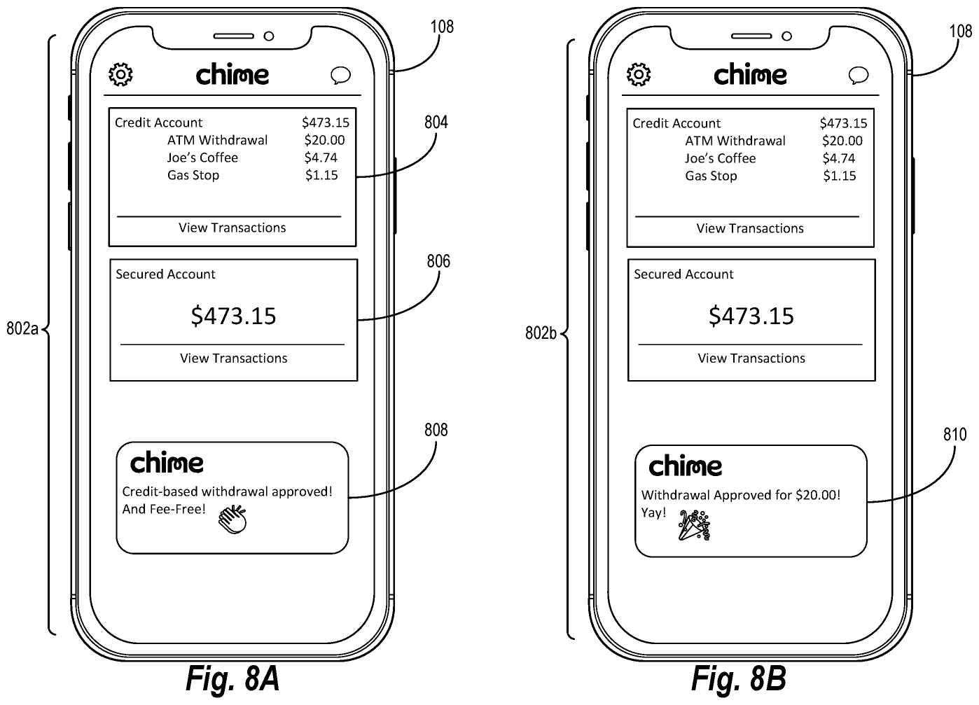

As just mentioned, in certain described embodiments, the fee-free credit withdrawal system 102 can suppress one or more fees associated with a credit-based withdrawal request. In particular, the fee-free credit withdrawal system 102 can suppress teller machine fees and/or out of network fees. FIG. 6 illustrates an example diagram for canceling fees for a credit-based withdrawal request in accordance with one or more embodiments.

As illustrated in FIG. 6, the fee-free credit withdrawal system 102 receives a credit-based withdrawal request 602 (e.g., the credit-based withdrawal request 504). In response to receiving the credit-based withdrawal request 602, the fee-free credit withdrawal system 102 determines whether the ATM transmitting the request is partnered with the fee-free credit withdrawal system 102 (or the inter-network facilitation system 104). Specifically, the fee-free credit withdrawal system 102 determines whether the ATM belongs to a partner network associated with an ATM system (e.g., the ATM system 112) partnered with the inter-network facilitation system 104. Thus, the fee-free credit withdrawal system 102 determines whether the ATM is an in network ATM 604 or an out of network ATM 606.

Based on determining that the credit-based withdrawal request 602 is from the in network ATM 604, the fee-free credit withdrawal system 102 determines that no fees apply to the credit-based withdrawal request 602. In certain embodiments, the fee-free credit withdrawal system 102 determines one or more in network fees or teller machine fees. The fee-free credit withdrawal system 102 can further suppress any fees associated with receiving the credit-based withdrawal request 602 from the in network ATM 604. For example, the fee-free credit withdrawal system 102 can reimburse any fee amounts applied to a credit account or a secured account. As another example, the fee-free credit withdrawal system 102 can provide a fee cancelation instruction to in network ATM 604 to cancel any fees before they are applied to the credit account or the secured account.

As further illustrated in FIG. 6, in some embodiments, the fee-free credit withdrawal system 102 receives the credit-based withdrawal request 602 from an out of network ATM 606. In particular, in response to receiving the credit-based withdrawal request 602, the fee-free credit withdrawal system 102 determines that the transmitting ATM is the out of network ATM 606. Specifically, the fee-free credit withdrawal system 102 determines that the out of network ATM 606 is not partnered with the fee-free credit withdrawal system 102 (or the inter-network facilitation system 104) and is therefore not part of a partner network associated with the ATM system 112.

Additionally, the fee-free credit withdrawal system 102 determines one or more fees associated with the credit-based withdrawal request 602 as a result of receiving the request from the out of network ATM 606. As shown, the fee-free credit withdrawal system 102 determines a teller machine fee 608. Specifically, the fee-free credit withdrawal system 102 determines a fee applied to the credit-based withdrawal request 602 by an owner of the out of network ATM 606, such as the ATM system 112. Additionally, the fee-free credit withdrawal system 102 determines an out of network fee 612 associated with the credit-based withdrawal request 602. Specifically, the fee-free credit withdrawal system 102 determines an out of network fee 612 that is applied by the inter-network facilitation system 104 and/or the credit processing system 110 for performing credit-based withdrawals via non-partnered ATMs.

As further illustrated in FIG. 6, the fee-free credit withdrawal system 102 performs an act 610 to suppress the teller machine fee 608. For example, fee-free credit withdrawal system 102 determines an amount of the teller machine fee 608 and reimburses the amount to the secured account or the credit account to which the fee was applied. In some cases, the fee-free credit withdrawal system 102 suppresses the teller machine fee 608 by providing a cancelation instruction to the out of network ATM 606 to cancel the fee before applying it to the credit account or the secured account.

Additionally, the fee-free credit withdrawal system 102 performs an act 614 to suppress the out of network fee 612. In particular, the fee-free credit withdrawal system 102 determines an amount of the out of network fee 612 (that would normally by) applied to a credit account or a secured account. In some cases, the fee-free credit withdrawal system 102 determines not to apply the out of network fee 612 internally and refrains from applying the fee. In other cases, the fee-free credit withdrawal system 102 provides a cancel notification to the credit processing system 110 and/or the secured account management system 116 to cancel the out of network fee 612 (e.g., in cases where these external systems process fees and transactions for the credit account and/or the secured account). In still other cases, the fee-free credit withdrawal system 102 reimburses the amount to the credit account or the secured account to ensure that the credit-based withdrawal request 602 is fee free.

As mentioned above, in certain described embodiments, the fee-free credit withdrawal system 102 determines whether an ATM terminal is partnered based on BINs associated with the ATM terminal. In particular, the fee-free credit withdrawal system 102 compares BINs associated with an ATM terminal with one or more BINs associated with the fee-free credit withdrawal system 102 or the inter-network facilitation system 104. FIG. 7 illustrates an example diagram of determining whether an ATM terminal is partnered (e.g., in network) based on comparing BINs in accordance with one or more embodiments.

As illustrated in FIG. 7, the fee-free credit withdrawal system 102 determines or identifies a BIN 702 associated with the inter-network facilitation system 104 (or the fee-free credit withdrawal system 102). For instance, the fee-free credit withdrawal system 102 determines a BIN that indicates or reflects a unique identity of the inter-network facilitation system 104 (or the credit processing system 110).

In addition, the fee-free credit withdrawal system 102 determines one or more BINs associated with the ATM terminal 706 (e.g., the ATM terminal 502). In some embodiments, the fee-free credit withdrawal system 102 accesses the ATM terminal 706 directly to determine one or more BINs known to, or stored within, the ATM terminal 706 (e.g., where stored BINs indicate in network systems). In other embodiments, the fee-free credit withdrawal system 102 accesses a repository of BINs 704 associated with the ATM system 112 that maintains the ATM terminal 706. The fee-free credit withdrawal system 102 further compares BINs stored within the repository of BINs 704 with the BIN 702. Upon determining that the repository of BINs 704 or the ATM terminal 706 itself stores or includes a BIN that matches the BIN 702, then the fee-free credit withdrawal system 102 determines that the ATM terminal 706 is in network, or partnered with the inter-network facilitation system 104.

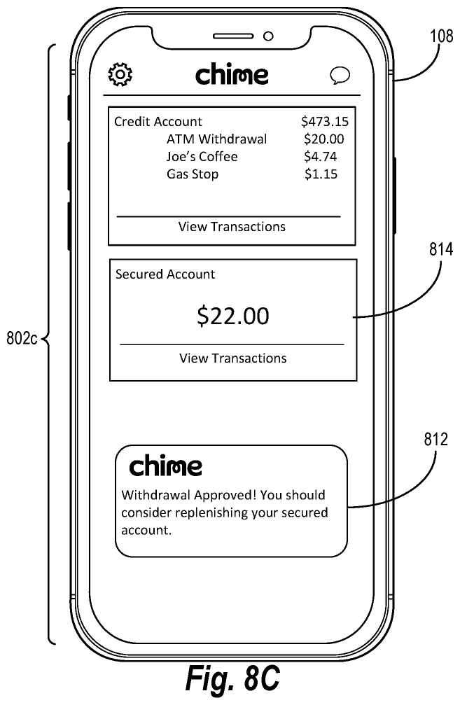

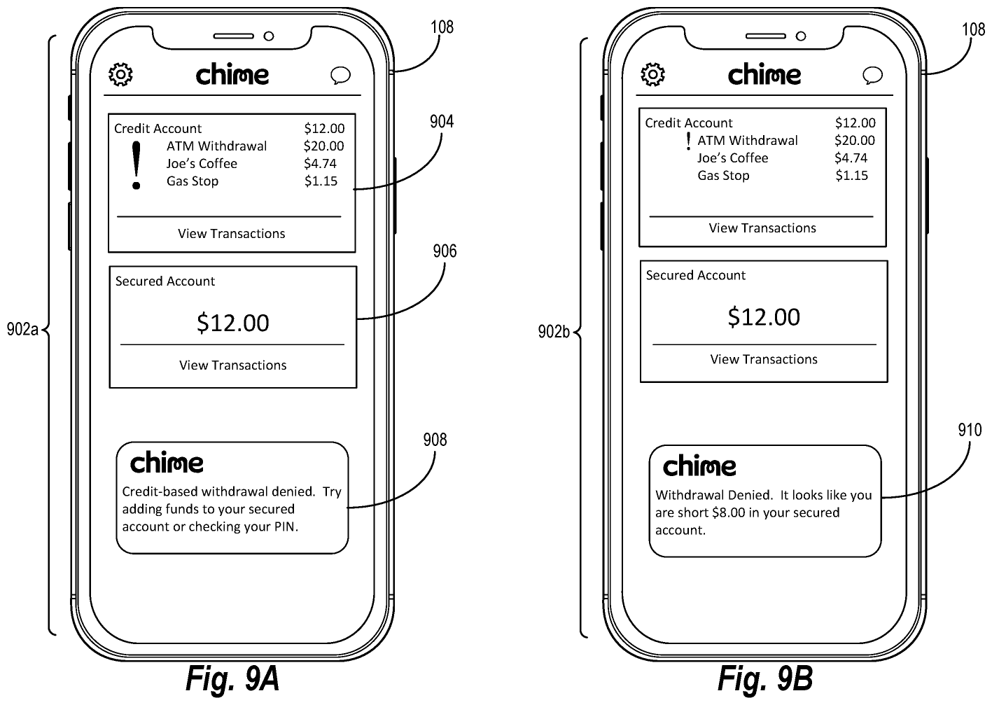

As mentioned above, in certain embodiments, the fee-free credit withdrawal system 102 can provide a notification for display on a client device (e.g., the client device 108) reflecting authorization or denial of a credit-based withdrawal request. In particular, the fee-free credit withdrawal system 102 can generate and provide an approval notification or a denial notification for display on the client device 108 based, respectively, on authorizing or denying a credit-based withdrawal request. Indeed, the fee-free credit withdrawal system 102 can generate and provide an approval or denial notification in response to receiving a credit-based withdrawal request (and authorizing or denying the request). FIGS. 8A-8C illustrate example graphical user interfaces including approval notifications associated with credit-based withdrawal requests in accordance with one or more embodiments. Thereafter, FIGS. 9A-8B illustrate example graphical user interfaces including denial notifications associated with credit-based withdrawal requests in accordance with one or more embodiments.

As illustrated in FIG. 8A, the fee-free credit withdrawal system 102 provides an approval notification 808 for display on the client device 108 within a graphical user interface 802a. In some embodiments, the approval notification 808 indicates that a credit-based withdrawal request has been approved or authorized. In one or more implementations, the approval notification 808 also indicates that the credit-based withdrawal request is approved on a fee-free basis (“And fee-free!”).

As shown in FIG. 8A, the graphical user interface 802a also includes a credit account element 804 and a secured account element 806. Within the credit account element 804, the fee-free credit withdrawal system 102 provides for display credit account information such as a credit limit and a listing of transactions including credit-based withdrawals and purchases. As shown, the credit account element 804 includes indications of an ATM withdrawal, a purchase at Joe's Coffee, and a purchase at Gas Stop. In addition, the secured account element 806 indicates a balance of a secured account linked to the credit account. Indeed, the secured account balance matches the credit limit indicated in the credit account element 804. In some embodiments, the credit account element is a condensed view of transactions and information regarding a credit account. In response to user interaction selecting the credit account element, the fee-free credit withdrawal system 102 provides a credit account interface for display that includes more transaction detail and additional credit account information.

In some cases, the fee-free credit withdrawal system 102 further indicates settled and unsettled (e.g., pending or denied) transactions within the credit account element 804. In particular, the fee-free credit withdrawal system 102 provides pending transaction icons or presents unsettled transactions in different fonts, different font colors, different font opacities, or different font weights from settled transactions. For example, the fee-free credit withdrawal system 102 can present a pending credit-based withdrawal request differently from a settled credit-based withdrawal request and further different from a denied credit-based withdrawal request. In some embodiments, the fee-free credit withdrawal system 102 presents in network credit-based withdrawal requests differently from out of network credit-based withdrawal requests (e.g., with different icons, different fonts, different font colors, different font opacities, or different font weights) within the credit account element 804.

In some cases, as illustrated in FIG. 8B, the approval notification 810 of the graphical user interface 802b further indicates an amount approved. For example, the fee-free credit withdrawal system 102 generates the approval notification 810 to indicate a full amount of an authorized credit-based withdrawal request. In certain embodiments, the fee-free credit withdrawal system 102 authorizes only a partial amount, or portion, of a credit-based withdrawal request for fee-free withdrawal, while either denying and/or authorizing with fees one or more other portions of the credit-based withdrawal request (e.g., based on a credit limit associated with a credit account). In these or other embodiments, the fee-free credit withdrawal system 102 generates the approval notification 810 to indicate the portion of the credit-based withdrawal request that is approved fee free, the portion of the credit-based withdrawal request that is approved with fees, and/or the portion of the credit-based withdrawal request that is denied.

As illustrated in FIG. 8C, the fee-free credit withdrawal system 102 can further generate an approval notification 812 to include additional information for display within the graphical user interface 802c. For example, the approval notification 812 includes a prompt to replenish a secured account. Indeed, in certain embodiments, the fee-free credit withdrawal system 102 determines a difference between a credit limit and a withdrawal amount of a credit-based withdrawal request. The fee-free credit withdrawal system 102 further compares the difference to a threshold difference and, if the difference is within the threshold, the fee-free credit withdrawal system 102 generates the approval notification 812 to prompt the user to add funds to the secured account (e.g., to increase the credit limit). As shown in the secured account element 814, the fee-free credit withdrawal system 102 determines a threshold of $10.00 and compares the secured account balance of $22.00 against the withdrawal amount of $20.00 for a difference of $2.00. Thus, the fee-free credit withdrawal system 102 generates the approval notification 812 to prompt adding funds. In some cases, the fee-free credit withdrawal system 102 can generate the approval notification to indicate an amount to add based that would make up the gap between the difference of the secured account balance and the withdrawal amount and the threshold (e.g., $8.00 in the above example).

In some cases, the fee-free credit withdrawal system 102 further indicates a recommended amount to add to the secured account. For instance, the fee-free credit withdrawal system 102 determines a pattern of credit usage associated with the credit limit and predicts, based on the pattern, that the credit account will have an insufficient credit limit for a subsequent credit-based withdrawal. In some cases, the fee-free credit withdrawal system 102 utilizes an insufficient credit limit prediction machine learning model, such as a neural network, trained to generate the prediction based on a credit usage pattern. Based on (or as part of) the prediction, the fee-free credit withdrawal system 102 further determines or predicts an amount that the credit limit is deficient in relation to a subsequent or future. Thus, the fee-free credit withdrawal system 102 can generate the approval notification 812 to indicate a recommended amount to add to the secured account to increase a credit limit.

Further, the fee-free credit withdrawal system 102 can indicate whether a credit-based withdrawal request is received from an in network ATM or an out of network ATM. Indeed, based on determining whether the ATM is in network, the fee-free credit withdrawal system 102 can generate the approval notification 812 to indicate that the credit-based withdrawal request is either in network or out of network. For instance, the fee-free credit withdrawal system 102 can generate an in network approval notification or an out of network approval notification that expressly spells out that the credit-based withdrawal request was in or out of the network (e.g., “In network withdrawal approved” or “Out of network withdrawal approved”). In some cases, the fee-free credit withdrawal system 102 generates the approval notification in a different color or with a different icon, font, or some other visible indication to differentiate between an in network approval notification and an out of network approval notification.

As illustrated in FIG. 9A, the client device 108 displays a graphical user interface 902a that includes a credit account element 904, a secured account element 906, and a denial notification 908. In particular, the fee-free credit withdrawal system 102 denies a credit-based withdrawal request based on comparing a credit limit with a withdrawal amount. In addition, the fee-free credit withdrawal system 102 generates the denial notification 908 to indicate that the credit-based withdrawal request was denied and to further prompt a user to add funds to a secured account. Indeed, the fee-free credit withdrawal system 102 determines that the credit-based withdrawal request of $20.00 exceeds the credit limit of $12.00 (as indicated by the balance of the secured account).

As further illustrated in FIG. 9A, the credit account element 904 includes credit account information including withdrawal and transactions. As shown, the credit account element 904 also includes or depicts a flag or some other denial indicator (e.g., the exclamation point) to indicate that there is an issue (e.g., that the credit-based withdrawal request is denied). In some cases, the fee-free credit withdrawal system 102 provides the exclamation for display in line with the indication of the credit-based withdrawal request to expressly indicate that the credit-based withdrawal request is denied (e.g., as shown in FIG. 9B). In addition, the secured account element 906 includes an indication of the balance within the secured account.

As illustrated in FIG. 9B, the fee-free credit withdrawal system 102 generates and provides a denial notification 910 for display within the graphical user interface 902b. Indeed, in some embodiments, the fee-free credit withdrawal system 102 denies a credit-based withdrawal request based on determining that a credit limit is insufficient. Based on denying the credit-based withdrawal request for this reason, the fee-free credit withdrawal system 102 can further generate and provide the denial notification to prompt a user to add funds to the secured account (e.g., to increase the credit limit). In some cases, the fee-free credit withdrawal system 102 determines an amount that the credit limit is deficient and generates the denial notification 910 to indicate the amount required to add to the secured account to authorize the credit-based withdrawal request (e.g., “It looks like you are short $8.00 in your secured account” or “Add $8.00 to your secured account for approval.”). As shown, the fee-free credit withdrawal system 102 determines that the credit limit or the secured account balance is $8.00 short of the $20.00 credit-based withdrawal request.

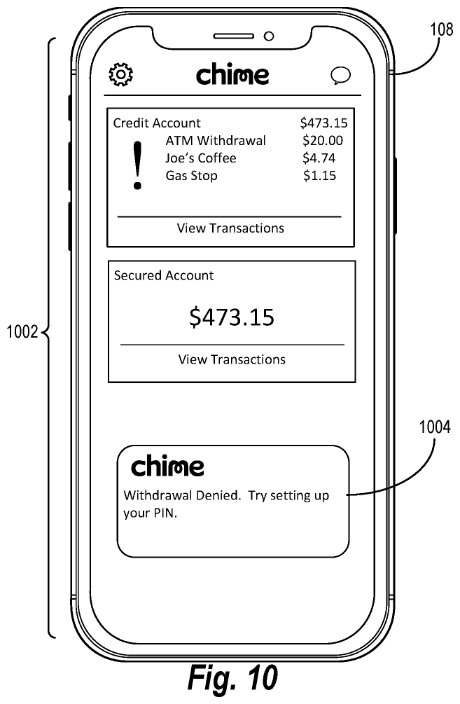

In one or more embodiments, the fee-free credit withdrawal system 102 generates and provides a denial notification based on a personal identification number (“PIN”) associated with a credit account. In particular, the fee-free credit withdrawal system 102 determines that a credit account does not have a PIN set up and cannot therefore authorize a credit-based withdrawal request. FIG. 10 illustrates an example graphical user interface including a denial notification prompting PIN setup in accordance with one or more embodiments.

As illustrated in FIG. 10, the client device 108 displays a graphical user interface 1002 that includes a denial notification 1004. Indeed, the fee-free credit withdrawal system 102 determines whether a credit account is associated with a PIN registered within the inter-network facilitation system 104 (and/or the credit processing system 110). The fee-free credit withdrawal system 102 can authorize a credit-based withdrawal request based on identifying a registered PIN (in addition to other factors described herein). In some cases, a single credit account has its own PIN, while in other cases a credit account is associated with multiple PINs, one for each respective credit card usable with the credit account.

In response to receiving a credit-based withdrawal request, the fee-free credit withdrawal system 102 determines whether the credit account has a PIN set up within the inter-network facilitation system 104 (and/or the credit processing system 110). In response to determining that no PIN is set up (or that the PIN is not completely or properly set up), the fee-free credit withdrawal system 102 generates and provides the denial notification 1004 that prompts a user to set up a PIN.

In some cases, the fee-free credit withdrawal system 102 further guides a user through setting up a PIN. For instance, the fee-free credit withdrawal system 102 receives user input (e.g., to select a PIN setup option with a denial notification or an email or a settings screen) and generates one or more graphical user interfaces (e.g., in a sequence) to guide a user through setting up a PIN for a credit account.

The components of the fee-free credit withdrawal system 102 can include software, hardware, or both. For example, the components of the fee-free credit withdrawal system 102 can include one or more instructions stored on a computer-readable storage medium and executable by processors of one or more computing devices (e.g., the computing device server(s) 106, the client device 108, and/or the ATM terminal 114). When executed by the one or more processors, the computer-executable instructions of the fee-free credit withdrawal system 102 can cause a computing device to perform the methods described herein. Alternatively, the components of the fee-free credit withdrawal system 102 can comprise hardware, such as a special purpose processing device to perform a certain function or group of functions. Additionally or alternatively, the components of the fee-free credit withdrawal system 102 can include a combination of computer-executable instructions and hardware.

Furthermore, the components of the fee-free credit withdrawal system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the fee-free credit withdrawal system 102 may be implemented as part of a stand-alone application on a personal computing device or a mobile device. Alternatively or additionally, the components of the fee-free credit withdrawal system 102 may be implemented in any application that allows creation and delivery of marketing content to users, including, but not limited to, various applications.

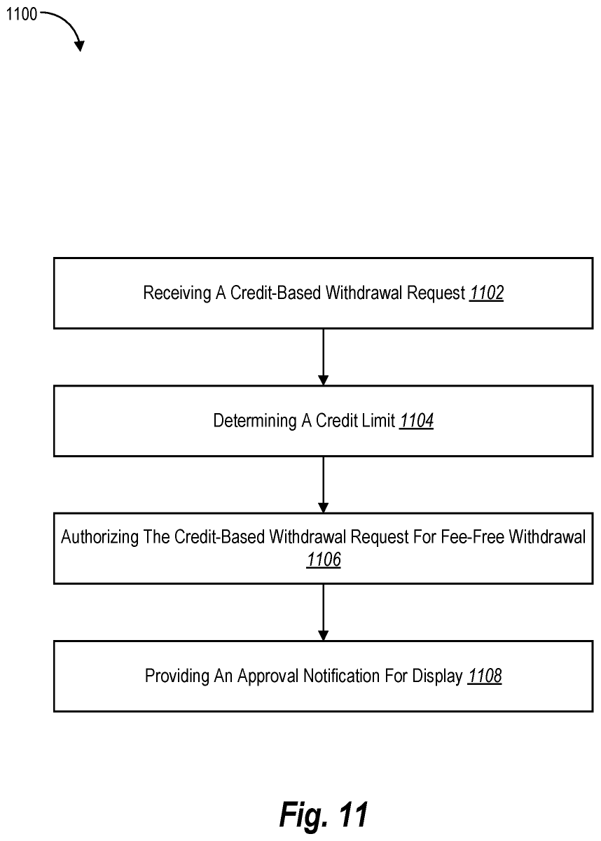

FIGS. 1-10, the corresponding text, and the examples provide a number of different systems, methods, and non-transitory computer readable media for facilitating credit-based withdrawal requests for fee-free withdrawal. In addition to the foregoing, embodiments can also be described in terms of flowcharts comprising acts for accomplishing a particular result. For example, FIG. 11 illustrates a flowchart of an example sequence of acts in accordance with one or more embodiments.

While FIG. 11 illustrates acts according to some embodiments, alternative embodiments may omit, add to, reorder, and/or modify any of the acts shown in FIG. 11. The acts of FIG. 11 can be performed as part of a method. Alternatively, a non-transitory computer readable medium can comprise instructions, that when executed by one or more processors, cause a computing device to perform the acts of FIG. 11. In still further embodiments, a system can perform the acts of FIG. 11. Additionally, the acts described herein may be repeated or performed in parallel with one another or in parallel with different instances of the same or other similar acts.

FIG. 11 illustrates an example series of acts 1100 for facilitating credit-based withdrawal requests on a fee-free basis across computing networks. The series of acts 1100 can include an act 1102 of receiving a credit-based withdrawal request. In particular, the act 1102 can involve receiving, by an inter-network facilitation system and from an automated teller machine, a credit-based withdrawal request associated with a credit account within the inter-network facilitation system linked to a secured account.

As shown, the series of acts 1100 can also include an act 1104 of determining a credit limit. In particular, the act 1104 can involve determining a credit limit associated with the credit account by accessing a balance of the secured account via an authorized network connection between the inter-network facilitation system and the secured account.

Further, the series of acts 1100 can include an act 1106 of authorizing the credit-based withdrawal request for fee-free withdrawal. In particular, the act 1106 can involve authorizing the credit-based withdrawal request for fee-free withdrawal from the automated teller machine based on comparing the credit limit associated with the credit account with an amount of the credit-based withdrawal request. In some embodiments, the act 1106 involves authorizing the credit-based withdrawal request for fee-free withdrawal from the automated teller machine by: comparing the credit limit associated with the credit account with an amount of the credit-based withdrawal request and suppressing one or more fees associated with the credit-based withdrawal request.

As further illustrated in FIG. 11, the series of acts 1100 can include an act 1108 of providing an approval notification for display. In particular, the act 1108 can involve providing, for display on a client device associated with the credit account, an approval notification indicating approval of the credit-based withdrawal request based on authorizing the credit-based withdrawal request. In some embodiments, the act 1108 involves providing, for display on a client device within an account interface associated with the credit account and based on authorizing the credit-based withdrawal request, a withdrawal notification indicating the amount of the credit-based withdrawal request.

In some embodiments, the series of acts 1100 includes an act of determining that the automated teller machine is not partnered with the inter-network facilitation system. Further, the series of acts 1100 can include an act of based on determining that the automated teller machine is not partnered with the inter-network facilitation system, suppressing the one or more fees associated with the credit-based withdrawal request. Indeed, the series of acts 1100 can include an act of, based on determining that the automated teller machine is not partnered with the inter-network facilitation system, authorizing the credit-based withdrawal request for fee-free withdrawal by suppressing one or more fees associated with the credit-based withdrawal request. Suppressing the one or more fees can include determining a teller machine fee applied to the secured account by the automated teller machine, determining an out of network fee applied to the secured account by the inter-network facilitation system, and reimbursing the teller machine fee and the out of network fee to the secured account. In some cases, suppressing the one or more fees includes determining a teller machine fee applied to the secured account by the automated teller machine, providing a fee cancelation instruction to the automated teller machine to remove the teller machine fee, determining an out of network fee applied to the secured account by the inter-network facilitation system, and reimbursing the out of network fee to the secured account.

The series of acts 1100 can include an act of receiving, from a second automated teller machine, a second credit-based withdrawal request associated with the credit account within the inter-network facilitation system linked to the secured account. The series of acts 1100 can also include acts of determining that the second automated teller machine is partnered with the inter-network facilitation system and in response to determining that the second automated teller machine is partnered with the inter-network facilitation system, authorizing the second credit-based withdrawal request for fee-free withdrawal without suppressing fees based on comparing the credit limit associated with the credit account with an amount of the credit-based withdrawal request.

In some cases, the series of acts 1100 includes an act of receiving, from the automated teller machine, a second credit-based withdrawal request associated with the credit account within the inter-network facilitation system linked to the secured account. Further, the series of acts 1100 can include an act of denying the second credit-based withdrawal request for fee-free withdrawal from the automated teller machine based on comparing the credit limit associated with the credit account with an amount of the second credit-based withdrawal request.

In certain embodiments, the series of acts 1100 includes an act of accessing a usage history associated with the credit account within the inter-network facilitation system. Additionally, the series of acts 1100 can include an act of determining, based on the usage history and the credit limit associated with the credit account, a fee-free limit amount for the credit account. Further, the series of acts 1100 can include an act of authorizing the credit-based withdrawal request for fee-free withdrawal from the automated teller machine up to the fee-free limit amount. In addition, the series of acts 1100 can include an act of authorizing the credit-based withdrawal request for fee-based withdrawal from the automated teller machine for amounts above the fee-free limit amount.

In some implementations, the series of acts 1100 includes an act of receiving, from the automated teller machine, a second credit-based withdrawal request associated with the credit account within the inter-network facilitation system linked to the secured account. Further, the series of acts 1100 includes acts of determining that an amount of the second credit-based withdrawal request exceeds the credit limit associated with the credit account, based on determining that the amount of the second credit-based withdrawal request exceeds the credit limit, determining a balance within a secondary account associated with the credit account within the inter-network facilitation system, and authorizing the second credit-based withdrawal request for fee-free withdrawal based on the balance within the secondary account. In some cases, the series of acts 1100 includes an act of, based on determining that the amount of the second credit-based withdrawal request exceeds the credit limit, providing a denial notification for display on the client device prompting additional funds to the secured account.

In some cases, authorizing the credit-based withdrawal request for fee-free withdrawal is based on a combined total of the credit limit associated with the credit account and the balance within the secondary account. The series of acts 1100 can also include an act of providing, for display on the client device based on determining that the amount of the second credit-based withdrawal request exceeds the credit limit and that the second credit-based withdrawal request was authorized based on the balance within the secondary account, an approval notification indicating approval of the second credit-based withdrawal request based on the balance within the secondary account. The series of acts 1100 can include an act of determining the balance within the secondary account based on an advancement amount applied to the credit account within the inter-network facilitation system.

The series of acts 1100 can include acts of determining a fee-free limit amount for the credit account based on a usage history associated with the credit account, authorizing the credit-based withdrawal request for fee-free withdrawal from the automated teller machine up to the fee-free limit amount, and authorizing the credit-based withdrawal request for fee-based withdrawal from the automated teller machine for an amount above the fee-free limit amount. The series of acts 1100 can also include an act of determining that the automated teller machine is partnered with the inter-network facilitation system by updating a repository of bank identification numbers (“BINs”) associated with the automated teller machine to include a BIN associated with the inter-network facilitation system. Further, the series of acts 1100 can include an act of authorizing the credit-based withdrawal request for fee-free withdrawal from the automated teller machine by determining that the credit account is associated with a personal identification number for using automated teller machines.

Additionally, the series of acts 1100 can include an act of receiving, from the automated teller machine, a denial indication indicating that the automated teller machine has determined to deny the credit-based withdrawal request associated with the credit account within the inter-network facilitation system linked to the secured account because an amount of the credit-based withdrawal request exceeds the credit limit associated with the credit account. The series of acts 1100 can also include an act of based on receiving the denial indication from the automated teller machine, overriding the denial indication by determining a balance within a secondary account associated with the credit account within the inter-network facilitation system and authorizing the credit-based withdrawal request for fee-free withdrawal based on the balance within the secondary account.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates, in block diagram form, an exemplary computing device 1200 (e.g., the client device 108, or the server(s) 106) that may be configured to perform one or more of the processes described above. As shown by FIG. 12, the computing device can comprise a processor 1202, memory 1204, a storage device 1206, an I/O interface 1208, and a communication interface 1210. In certain embodiments, the computing device 1200 can include fewer or more components than those shown in FIG. 12. Components of computing device 1200 shown in FIG. 12 will now be described in additional detail.

In particular embodiments, processor(s) 1202 includes hardware for executing instructions, such as those making up a computer program. As an example, and not by way of limitation, to execute instructions, processor(s) 1202 may retrieve (or fetch) the instructions from an internal register, an internal cache, memory 1204, or a storage device 1206 and decode and execute them.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 1204 may be internal or distributed memory.

The computing device 1200 includes a storage device 1206 includes storage for storing data or instructions. As an example, and not by way of limitation, storage device 1206 can comprise a non-transitory storage medium described above. The storage device 1206 may include a hard disk drive (“HDD”), flash memory, a Universal Serial Bus (“USB”) drive or a combination of these or other storage devices.

The computing device 1200 also includes one or more input or output interface 1208 (or “I/O interface 1208”), which are provided to allow a user (e.g., requester or provider) to provide input to (such as user strokes), receive output from, and otherwise transfer data to and from the computing device 1200. These I/O interface 1208 may include a mouse, keypad or a keyboard, a touch screen, camera, optical scanner, network interface, modem, other known I/O devices or a combination of such I/O interface 1208. The touch screen may be activated with a stylus or a finger.

The I/O interface 1208 may include one or more devices for presenting output to a user, including, but not limited to, a graphics engine, a display (e.g., a display screen), one or more output providers (e.g., display providers), one or more audio speakers, and one or more audio providers. In certain embodiments, interface 1208 is configured to provide graphical data to a display for presentation to a user. The graphical data may be representative of one or more graphical user interfaces and/or any other graphical content as may serve a particular implementation.

The computing device 1200 can further include a communication interface 1210. The communication interface 1210 can include hardware, software, or both. The communication interface 1210 can provide one or more interfaces for communication (such as, for example, packet-based communication) between the computing device and one or more other computing devices 1200 or one or more networks. As an example, and not by way of limitation, communication interface 1210 may include a network interface controller (“NIC”) or network adapter for communicating with an Ethernet or other wire-based network or a wireless NIC (“WNIC”) or wireless adapter for communicating with a wireless network, such as a WI-FI. The computing device 1200 can further include a bus 1212. The bus 1212 can comprise hardware, software, or both that connects components of computing device 1200 to each other.

FIG. 13 illustrates an example network environment 1300 of the inter-network facilitation system 104. The network environment 1300 includes a client device 1306 (e.g., client device 108), an inter-network facilitation system 104, and a third-party system 1308 connected to each other by a network 1304. Although FIG. 13 illustrates a particular arrangement of the client device 1306, the inter-network facilitation system 104, the third-party system 1308, and the network 1304, this disclosure contemplates any suitable arrangement of client device 1306, the inter-network facilitation system 104, the third-party system 1308, and the network 1304. As an example, and not by way of limitation, two or more of client device 1306, the inter-network facilitation system 104, and the third-party system 1308 communicate directly, bypassing network 1304. As another example, two or more of client device 1306, the inter-network facilitation system 104, and the third-party system 1308 may be physically or logically co-located with each other in whole or in part.

Moreover, although FIG. 13 illustrates a particular number of client devices 1306, inter-network facilitation systems 104, third-party systems 1308, and networks 1304, this disclosure contemplates any suitable number of client devices 1306, inter-network facilitation system 104, third-party systems 1308, and networks 1304. As an example, and not by way of limitation, network environment 1300 may include multiple client devices 1306, inter-network facilitation system 104, third-party systems 1308, and/or networks 1304.

This disclosure contemplates any suitable network 1304. As an example, and not by way of limitation, one or more portions of network 1304 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1304 may include one or more networks 1304.

Links may connect client device 1306, the inter-network facilitation system 104 (which hosts the fee-free credit withdrawal system 102), and third-party system 1308 to network 1304 or to each other. This disclosure contemplates any suitable links. In particular embodiments, one or more links include one or more wireline (such as for example Digital Subscriber Line (“DSL”) or Data Over Cable Service Interface Specification (“DOC SIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1300. One or more first links may differ in one or more respects from one or more second links.

In particular embodiments, the client device 1306 may be an electronic device including hardware, software, or embedded logic components or a combination of two or more such components and capable of carrying out the appropriate functionalities implemented or supported by client device 1306. As an example, and not by way of limitation, a client device 1306 may include any of the computing devices discussed above in relation to FIG. 12. A client device 1306 may enable a network user at the client device 1306 to access network 1304. A client device 1306 may enable its user to communicate with other users at other client devices 1306.

In particular embodiments, the client device 1306 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1306 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1306 one or more Hyper Text Markup Language (“HTML”) files responsive to the HTTP request. The client device 1306 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 1304) to link the third-party-system 1308. For example, the inter-network facilitation system 104 may receive authentication credentials from a user to link a third-party system 1308 such as an online bank account, credit account, debit account, or other financial account to a user account within the inter-network facilitation system 104. The inter-network facilitation system 104 can subsequently communicate with the third-party system 1308 to detect or identify balances, transactions, withdrawal, transfers, deposits, credits, debits, or other transaction types associated with the third-party system 1308. The inter-network facilitation system 104 can further provide the aforementioned or other financial information associated with the third-party system 1308 for display via the client device 1306. In some cases, the inter-network facilitation system 104 links more than one third-party system 1308, receiving account information for accounts associated with each respective third-party system 1308 and performing operations or transactions between the different systems via authorized network connections.

In particular embodiments, the inter-network facilitation system 104 may interface between an online banking system and a credit processing system via the network 1304. For example, the inter-network facilitation system 104 can provide access to a bank account of a third-party system 1308 and linked to a user account within the inter-network facilitation system 104. Indeed, the inter-network facilitation system 104 can facilitate access to, and transactions to and from, the bank account of the third-party system 1308 via a client application of the inter-network facilitation system 104 on the client device 1306. The inter-network facilitation system 104 can also communicate with a credit processing system, an ATM system, and/or other financial systems (e.g., via the network 1304) to authorize and process credit charges to a credit account, perform ATM transactions, perform transfers (or other transactions) across accounts of different third-party systems 1308, and to present corresponding information via the client device 1306.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 1308), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 1300 either directly or via network 1304. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1306, or an inter-network facilitation system 104 to manage, retrieve, modify, add, or delete, the information stored in data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 1304.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles and/or account information for credit accounts, secured accounts, secondary accounts, and other affiliated financial networking system accounts. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 1306. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 1306. Information may be pushed to a client device 1306 as notifications, or information may be pulled from client device 1306 responsive to a request received from client device 1306. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 1306 associated with users.

In addition, the third-party system 1308 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 1304. A third-party system 1308 can communicate with the inter-network facilitation system 104 to provide financial information pertaining to balances, transactions, and other information, whereupon the inter-network facilitation system 104 can provide corresponding information for display via the client device 1306. In particular embodiments, a third-party system 1308 communicates with the inter-network facilitation system 104 to update account balances, transaction histories, credit usage, and other internal information of the inter-network facilitation system 104 and/or the third-party system 1308 based on user interaction with the inter-network facilitation system 104 (e.g., via the client device 1306). Indeed, the inter-network facilitation system 104 can synchronize information across one or more third-party systems 1308 to reflect accurate account information (e.g., balances, transactions, etc.) across one or more networked systems, including instances where a transaction (e.g., a transfer) from one third-party system 1308 affects another third-party system 1308.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A system comprising:
at least one processor; and
a non-transitory computer readable medium comprising instructions that, when executed by the at least one processor, cause the system to:
receive, by an inter-network facilitation system and from an automated teller machine, a credit-based withdrawal request associated with a credit account within the inter-network facilitation system linked to a secured account;
determine a credit limit associated with the credit account by accessing a balance of the secured account via an authorized network connection between the inter-network facilitation system and the secured account;
authorize the credit-based withdrawal request for fee-free withdrawal from the automated teller machine by:
comparing the credit limit associated with the credit account with an amount of the credit-based withdrawal request; and
suppressing one or more fees associated with the credit-based withdrawal request; and
provide, for display on a client device associated with the credit account based on authorizing the credit-based withdrawal request, an approval notification indicating approval of the credit-based withdrawal request.

2. The system of claim 1, further comprising instructions that, when executed by the at least one processor, cause the system to:
determine that the automated teller machine is not partnered with the inter-network facilitation system; and
based on determining that the automated teller machine is not partnered with the inter-network facilitation system, suppress the one or more fees associated with the credit-based withdrawal request by:
determining a teller machine fee applied to the secured account by the automated teller machine;
determining an out of network fee applied to the secured account by the inter-network facilitation system; and
reimbursing the teller machine fee and the out of network fee to the secured account.

3. The system of claim 1, further comprising instructions that, when executed by the at least one processor, cause the system to:
receive, from a second automated teller machine, a second credit-based withdrawal request associated with the credit account within the inter-network facilitation system linked to the secured account;
determine that the second automated teller machine is partnered with the inter-network facilitation system; and
in response to determining that the second automated teller machine is partnered with the inter-network facilitation system, authorize the second credit-based withdrawal request for fee-free withdrawal without suppressing fees based on comparing the credit limit associated with the credit account with an amount of the credit-based withdrawal request.

4. The system of claim 1, further comprising instructions that, when executed by the at least one processor, cause the system to:
receive, from the automated teller machine, a second credit-based withdrawal request associated with the credit account within the inter-network facilitation system linked to the secured account; and
deny the second credit-based withdrawal request for fee-free withdrawal from the automated teller machine based on comparing the credit limit associated with the credit account with an amount of the second credit-based withdrawal request.

5. The system of claim 1, further comprising instructions that, when executed by the at least one processor, cause the system to:
access a usage history associated with the credit account within the inter-network facilitation system;
determine, based on the usage history and the credit limit associated with the credit account, a fee-free limit amount for the credit account;
authorize the credit-based withdrawal request for fee-free withdrawal from the automated teller machine up to the fee-free limit amount; and
authorize the credit-based withdrawal request for fee-based withdrawal from the automated teller machine for amounts above the fee-free limit amount.

6. The system of claim 1, further comprising instructions that, when executed by the at least one processor, cause the system to:
receive, from the automated teller machine, a second credit-based withdrawal request associated with the credit account within the inter-network facilitation system linked to the secured account;
determine that an amount of the second credit-based withdrawal request exceeds the credit limit associated with the credit account;
based on determining that the amount of the second credit-based withdrawal request exceeds the credit limit, determine a balance within a secondary account associated with the credit account within the inter-network facilitation system; and
authorize the second credit-based withdrawal request for fee-free withdrawal based on the balance within the secondary account.

7. The system of claim 6, further comprising instructions that, when executed by the at least one processor, cause the system to provide, for display on the client device based on determining that the amount of the second credit-based withdrawal request exceeds the credit limit and that the second credit-based withdrawal request was authorized based on the balance within the secondary account, an approval notification indicating approval of the second credit-based withdrawal request based on the balance within the secondary account.

8. A method comprising:
receiving, by an inter-network facilitation system and from an automated teller machine, a credit-based withdrawal request associated with a credit account within the inter-network facilitation system linked to a secured account;
determining a credit limit associated with the credit account by accessing a balance of the secured account via an authorized network connection between the inter-network facilitation system and the secured account;
authorizing the credit-based withdrawal request for fee-free withdrawal from the automated teller machine based on comparing the credit limit associated with the credit account with an amount of the credit-based withdrawal request; and
providing, for display on a client device associated with the credit account, an approval notification indicating approval of the credit-based withdrawal request based on authorizing the credit-based withdrawal request.

9. The method of claim 8, further comprising:
determining that the automated teller machine is not partnered with the inter-network facilitation system; and
based on determining that the automated teller machine is not partnered with the inter-network facilitation system, authorizing the credit-based withdrawal request for fee-free withdrawal by suppressing one or more fees associated with the credit-based withdrawal request.

10. The method of claim 8, further comprising:
determining that the automated teller machine is partnered with the inter-network facilitation system; and
based on determining that the automated teller machine is partnered with the inter-network facilitation system, authorizing the credit-based withdrawal request for fee-free withdrawal without suppressing fees associated with the credit-based withdrawal request.

11. The method of claim 8, further comprising:
determining a fee-free limit amount for the credit account based on a usage history associated with the credit account;
authorizing the credit-based withdrawal request for fee-free withdrawal from the automated teller machine up to the fee-free limit amount; and
authorizing the credit-based withdrawal request for fee-based withdrawal from the automated teller machine for an amount above the fee-free limit amount.

12. The method of claim 8, further comprising:
determining that the amount of the credit-based withdrawal request exceeds the credit limit associated with the credit account;
based on determining that the amount of the credit-based withdrawal request exceeds the credit limit, determining a balance within a secondary account associated with the credit account within the inter-network facilitation system; and
authorizing the credit-based withdrawal request for fee-free withdrawal based on a combined total of the credit limit associated with the credit account and the balance within the secondary account.

13. The method of claim 12, further comprising determining the balance within the secondary account based on an advancement amount applied to the credit account within the inter-network facilitation system.

14. The method of claim 8, further comprising, in response to authorizing the credit-based withdrawal request for fee-free withdrawal:
determining a teller machine fee applied to the secured account by the automated teller machine;
determining an out of network fee applied to the secured account by the inter-network facilitation system; and
reimbursing the teller machine fee and the out of network fee to the secured account.

15. A non-transitory computer readable medium comprising instructions that, when executed by at least one processor, cause a computing device to:
receive, by an inter-network facilitation system and from an automated teller machine, a credit-based withdrawal request associated with a credit account within the inter-network facilitation system linked to a secured account;
determine a credit limit associated with the credit account by accessing a balance of the secured account via an authorized network connection between the inter-network facilitation system and the secured account;
authorize the credit-based withdrawal request for fee-free withdrawal from the automated teller machine based on comparing the credit limit associated with the credit account with an amount of the credit-based withdrawal request; and
provide, for display on a client device within an account interface associated with the credit account and based on authorizing the credit-based withdrawal request, a withdrawal notification indicating the amount of the credit-based withdrawal request.

16. The non-transitory computer readable medium of claim 15, further comprising instructions that, when executed by the at least one processor, cause the computing device to:
determine that the automated teller machine is not partnered with the inter-network facilitation system; and
based on determining that the automated teller machine is not partnered with the inter-network facilitation system, suppress one or more fees associated with the credit-based withdrawal request by:
determining a teller machine fee applied to the secured account by the automated teller machine;
providing a fee cancelation instruction to the automated teller machine to remove the teller machine fee;
determining an out of network fee applied to the secured account by the inter-network facilitation system; and
reimbursing the out of network fee to the secured account.

17. The non-transitory computer readable medium of claim 15, further comprising instructions that, when executed by the at least one processor, cause the computing device to:
receive, from the automated teller machine, a denial indication indicating that the automated teller machine has determined to deny the credit-based withdrawal request associated with the credit account within the inter-network facilitation system linked to the secured account because an amount of the credit-based withdrawal request exceeds the credit limit associated with the credit account; and
based on receiving the denial indication from the automated teller machine, override the denial indication by:
determining a balance within a secondary account associated with the credit account within the inter-network facilitation system; and
authorizing the credit-based withdrawal request for fee-free withdrawal based on the balance within the secondary account.

18. The non-transitory computer readable medium of claim 15, further comprising instructions that, when executed by the at least one processor, cause the computing device to:
receive, from the automated teller machine, a second credit-based withdrawal request associated with the credit account within the inter-network facilitation system linked to the secured account;
determine that an amount of the second credit-based withdrawal request exceeds the credit limit associated with the credit account; and
based on determining that the amount of the second credit-based withdrawal request exceeds the credit limit, provide a denial notification for display on the client device prompting additional funds to the secured account.

19. The non-transitory computer readable medium of claim 15, further comprising instructions that, when executed by the at least one processor, cause the computing device to determine that the automated teller machine is partnered with the inter-network facilitation system by updating a repository of bank identification numbers (“BINs”) associated with the automated teller machine to include a BIN associated with the inter-network facilitation system.

20. The non-transitory computer readable medium of claim 19, further comprising instructions that, when executed by the at least one processor, cause the computing device to authorize the credit-based withdrawal request for fee-free withdrawal from the automated teller machine by determining that the credit account is associated with a personal identification number for using automated teller machines.
